(19) United States
(12) Patent Application Publication
(10) Pub. No.: US 2025/0049027 A1
(43) Pub. Date: Feb. 13, 2025

(54) PLANT PATHOGEN COMPOSITION

(71) Applicant: Robjulz Pty. Ltd., Nar Nar Goon, Victoria (AU)

(72) Inventors: Barry John Wilson, Beaconsfield (AU); Robert Hovell, Pakenham (AU); Robert John Savage, Beaconsfield Upper (AU)

(73) Assignee: Robjulz Pty. Ltd., Nar Nar Goon, Victoria (AU)

(21) Appl. No.: 18/719,781

(22) PCT Filed: Dec. 14, 2022
(86) PCT No.: PCT/AU2022/051510

§ 371 Date: Jun. 13, 2024

(30) Foreign Application Priority Data
Dec. 14, 2021 (AU) 2021904061

(51) Int. Cl. A01N 33/12; A01N 25/24; A01N 25/30; A01P 3/00; A01P 15/00

(52) U.S. Cl. CPC A01N 33/12; A01N 25/24; A01N 25/30; A01P 3/00; A01P 15/00

(57) ABSTRACT

The invention relates to chemical compositions comprising a benzalkonium compound, a penetration enhancer, a surfactant, and a polymeric film-forming agent, and their use to control fungi or fungus-like pathogens on plants and in soil.

This application is a PCT application filed on 14 Dec. 2022, which claims priority to Australian provisional application No. 2021904061, filed on 14 Dec. 2021, the entire contents of which are incorporated by this reference.

### FIELD OF THE INVENTION

The present invention relates to chemical compositions that have a fungicidal effect, and methods of using such compositions to inhibit or kill fungi, or fungus-like organisms, and/or their spores.

### BACKGROUND OF THE INVENTION

Fungi, and fungus-like life forms such as oomycetes, are eukaryotic microorganisms that perform essential roles in nature, however, the uncontrolled proliferation of these organisms can lead to diseases in animals and plants. Due to the ease of travel and global trade, such organisms are widely distributed. The present invention relates to the treatment of plant diseases that are caused by fungi and related organisms such as oomycetes.

Diseases caused by fungi and fungus-like organisms affect not only native trees, but also plants of economic importance such as food crops and managed forests. One such disease is Panama disease, also known as banana wilt or fusarium wilt, which affects banana plants. Panama disease is caused by the fungus Fusarium oxysporum forma specialis cubense (Foc). During the 1950s and 1960s, Panama disease decimated Gros Michel banana plantations worldwide, which was the dominant cultivar at the time, forcing many growers to switch to Fusarium-resistant cultivars such as the Cavendish banana. At present, the Cavendish banana is the world's most popular cultivar, with an estimated harvest of around 50 billion tonnes per year which accounts for about 47% of global production. However, Cavendish bananas are susceptible to a particular strain of Panama disease known as Tropical Race 4 (FocTR4), which has been reported to attack nearly all varieties of bananas. Management of this disease ranges from stringent biosecurity measures to prevent or contain the disease, to removal and quarantining of infected soil. New crops planted in these areas will also be susceptible to the fungus, and the fungus can survive for decades in soil without host plants, so quarantining of infected soil prevents other crops from being planted in the same soil. To date, fungicides in commercial Cavendish banana farms have proven to be unsuccessful at controlling FocTR4, with many growers relying on the development of other Fusarium-resistant cultivars to overcome this fungus.

Another important crop disease is caused by Phytophthora palmivora, which is an oomycete. Oomycetes share many similarities with fungi, although molecular and phylogenetic studies display significant differences, leading taxonomists to distinguish between the two. Phytophthora palmivora causes pod rot of cocoa, and stem canker of durian and rubber, amongst others, affecting the fruit or stem of the tree rather than the roots.

Phytophthora cinnamomi, also known as cinnamon fungus, is an example of a soil-borne oomycete known to cause dieback and death of susceptible plants, particularly members of the pine and eucalypt families. The spread of this oomycete is not only an ecological problem but an economic one that threatens the economy of several industries including forest products and garden nurseries.

Efforts have been made in the past to counter the spread of fungi and fungus-like organisms by the use of selective chemicals. These formulations typically contain hypochlorite or chlorine derivatives, and are used to wash down tools, vehicles and other equipment prior to their removal from infected areas in which the organisms grow. Although the hypochlorite and chlorine derivatives are effective, they are quickly inactivated by contact with organic matter. Furthermore, these chemicals have other occupational hazards, such as the production of carcinogenic or toxic by-products if contacted with formaldehyde or acid, and they may also be corrosive towards metal, rubber and other susceptible surfaces, or they may cause damage such as leaf browning to the plants being treated. Potassium phosphite, or other phosphites such as calcium or magnesium phosphites, have been used as a biodegradable fungicide to prevent plants from being infected with Phytophthora, but their efficacy once a plant has already been infected is poor.

One problem with chemical compositions used previously is that their application has been limited to washdown formulations, such as to sterilise equipment, footwear and clothing being moved from an infested area to an uninfested area. These compositions have not, to date, been directly applied to plants such as trees, due to the reasons discussed above.

Therefore, there is a need to provide a fungicidal composition that can control fungi and fungus-like organisms and/or their spores, without poisoning soil or adversely affecting higher plants.

### SUMMARY OF THE INVENTION

In one aspect, the present invention provides a composition for controlling a plant pathogen, wherein the composition comprises (a) a benzalkonium compound; (b) a penetration enhancer; (c) a surfactant; and (d) a polymeric film-forming agent.

In another aspect, the present invention provides a use of a composition to control a plant pathogen in soil, comprising applying to the soil a composition comprising (a) a benzalkonium compound, (b) a penetration enhancer, (c) a surfactant, and (d) a polymeric film-forming agent.

In another aspect, the present invention provides a method of controlling a plant pathogen, comprising contacting the plant pathogen with an effective amount of a composition comprising (a) a benzalkonium compound, (b) a penetration enhancer, (c) a surfactant, and (d) a polymeric film-forming agent.

In another aspect, the present invention provides a method of controlling a plant pathogen in a crop of plants, comprising applying to the crop of plants a composition comprising (a) a benzalkonium compound, (b) a penetration enhancer, (c) a surfactant, and (d) a polymeric film-forming agent.

In another aspect, the present invention provides a method of controlling a plant pathogen in soil, comprising applying to the soil a composition comprising (a) a benzalkonium compound, (b) a penetration enhancer, (c) a surfactant, and (d) a polymeric film-forming agent.

In another aspect, the present invention provides a use of a composition to control Phytophthora and/or Fusarium in soil, comprising applying to the soil a composition comprising (a) a benzalkonium compound, (b) a penetration enhancer, and (c) a surfactant.

In another aspect, the present invention provides a method of controlling Phytophthora and/or Fusarium, comprising contacting the plant pathogen with an effective amount of a composition comprising (a) a benzalkonium compound, (b) a penetration enhancer, and (c) a surfactant.

In another aspect, the present invention provides a method of controlling Phytophthora and/or Fusarium in a crop of plants, comprising applying to the crop of plants a composition comprising (a) a benzalkonium compound, (b) a penetration enhancer, and (c) a surfactant.

In another aspect, the present invention provides a method of controlling Phytophthora and/or Fusarium in soil, comprising applying to the soil a composition comprising (a) a benzalkonium compound, (b) a penetration enhancer, and (c) a surfactant.

Other aspects of the present invention will become apparent to those ordinarily skilled in the art upon review of the following description of specific embodiments of the invention.

### FIGURES

For a further understanding of the aspects and advantages of the present invention, reference should be made to the following detailed description, taken in conjunction with the accompanying drawings.

FIG. 1 shows mycelial growth of Phytophthora palmivora after 7 days of incubation against various compositions comprising a benzalkonium compound in accordance with some embodiments of the invention. The benzalkonium compound was benzalkonium chloride (BAC), and concentrations of the compositions ranged from 0 ppm to 72 ppm, based on the amount of BAC present.

FIG. 2 shows mycelial growth of FocTR4 after 7 days of incubation against various compositions comprising a benzalkonium compound in accordance with some embodiments of the invention. The benzalkonium compound was benzalkonium chloride (BAC) and concentrations of the compositions ranged from 90 ppm to 450 ppm, based on the amount of BAC present. Plates on the left of each picture are samples with the stated concentration of the composition and plates on the right are control samples containing no BAC.

FIG. 3 shows results of inhibition testing of cocoa pods infected with P. palmivora, in accordance with some embodiments of the invention. (A) control samples: all five pods show fungal infection around plug; (B) pods treated with 18 ppm BAC: four out of five pods show fungal infection around plug; (C) pods treated with 36 ppm BAC: four out of five pods show fungal infection around plug; (D) pods treated with 54 ppm BAC: three out of five pods show fungal infection around plug; (E) pods treated with 72 ppm BAC: two out of five pods show fungal infection around plug; (F)-(I) pods treated with 90 ppm, 180 ppm, 360 ppm, and 540 ppm BAC, respectively: no fungal infection around plug.

FIG. 4 shows droplet spreading of a composition on glass, in accordance with one embodiment of the invention. Left: control solution comprising 500 ppm of BAC. Right: test solution comprising 500 ppm of BAC and poly(acrylamide-co-acrylic acid) as polymeric film-forming agent.

FIG. 5 shows platform used to assess tilt angle required to move a droplet of a composition in accordance with embodiments of the invention. Top: the starting position with a droplet on the left side of a slide. Bottom: The final position of the platform when the droplet had begun to move down the slide.

FIG. 6 shows droplets of test solutions, in accordance with some embodiments of the invention, on various surfaces: (A) glass slide with a droplet of DI water (left) and a droplet of a composition comprising a polymeric film-forming agent (right); (B) leek with alternating droplets of DI water (1^{st} and 3^{rd} drops) and a composition comprising a polymeric film-forming agent (2^{nd} and 4^{th} drops); (C) orange peel with DI water (left) and a composition comprising a polymeric film-forming agent (right); and (D) Hypochaeris radicata with DI water (lower left) and a composition comprising a polymeric film-forming agent (upper right). The polymeric film-forming agent was poly(acrylamide-co-acrylic acid).

### DETAILED DESCRIPTION OF THE INVENTION

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, the term “a surfactant” means one type of surfactant or more than one type of surfactant.

As used herein, the term “about” means that the quantity stated may vary by a small amount. For example, the term “about 98”, in the context of the ratio “about 98:2” means that the first component may be present in an amount of from 97.5 to 98.5 parts, and the second component may be present in an amount of from 1.5 to 2.5 parts. As such, small variations within ratios are within the scope of the invention. In other contexts, the term “about” means a quantity, level, value, dimension, size, or amount that varies by +10% to a reference quantity, level, value, dimension, size, or amount. For example, the term “about 30%” is intended to mean that the value may be as little as 27% or as much as 33%. The skilled artisan will be able to discern the meaning of the term “about” in keeping with the spirit of the invention.

A ratio of two components may be provided in whole numbers or as a rational number. For example, a ratio of A:B of 90:10 can also be expressed as 9:1 or 9.0.

In one aspect, the present invention provides a composition for controlling a plant pathogen, wherein the composition comprises:
(a) a benzalkonium compound;
(b) a penetration enhancer;
(c) a surfactant; and
(d) a polymeric film-forming agent.

A benzalkonium compound is a component that is identifiable by its chemical structure. Generally speaking, penetration enhancers, surfactants and polymeric film-forming agents are components consisting of chemical compounds and are identifiable by their ability to function as penetration enhancers, surfactants and polymeric film-forming agents, respectively. In some instances, a component may be identifiable as two or more of a benzalkonium compound, penetration enhancer, surfactant and a film-forming agent. For example, a component may function, and may thus be identifiable, as both a penetration enhancer and a surfactant. In which case, in embodiments within this example, the composition for controlling a plant pathogen may comprise three components; a benzalkonium compound, a compound which is a polymeric film-forming agent, and a compound which is both a penetration enhancer and a surfactant.

In preferred embodiments, each of the benzalkonium compound, penetration enhancer, surfactant and film-forming agent is a separate component. In which case the composition for controlling a plant pathogen may be said to comprise each of (a) a benzalkonium compound; (b) a penetration enhancer; (c) a surfactant; and (d) a polymeric film-forming agent as a separate component. In which case, the composition comprises at least four components, one which is identifiable as at least a benzalkonium compound, another which is identifiable as at least a penetration enhancer, another which is identifiable as at least a surfactant, and another which is identifiable as at least a polymeric film-forming agent. This is preferred because a component with properties that make it identifiable under two or more of these categories is less likely to be as effective in at least one category as compared with a component that is identifiable in only that category. For example, a component that is identifiable as a penetration enhancer and a surfactant is less likely to have as effective penetrating abilities to e.g. facilitate entry through a cell wall, as a component that is identifiable as a penetration enhancer only, and less likely to have as effective surfactant properties to e.g. assist in making a homogenous, non-foaming composition, as a component that is identifiable as a surfactant only. In preferred embodiments, each of components (a), (b), (c) and (d) are separately-defined components, meaning that each is identifiable under one of categories (a), (b), (c) and (d) but not any of the others, in compositions of the present invention.

The composition has a number of advantages over compositions that only contain the benzalkonium compound, or only contain the benzalkonium compound and a penetration enhancer (such as sodium tripolyphosphate). One advantage is that the composition is able to adhere to the plant or soil without washing away too quickly. The adherence of the composition on plants or soil allows application of the benzalkonium compound at a lower rate than if the benzalkonium compound (or benzalkonium compound and penetration enhancer) was administered by itself. Another advantage is that the composition is homogeneous, rather than existing in multiple phases, which facilitates application of the composition to a plant or soil, as a separate mixing device is not required at the point of application of the composition. Another advantage is that the composition has good spreadability, which allows the composition to be applied evenly over an area. It will be understood that the composition may be sold as a concentrated solution, that may be diluted with a suitable solvent or solvents to the appropriate concentration before being applied.

As used herein, the term “control”, “controlling”, and similar terms means that the composition is able to halt or reduce the rate of proliferation or reduce a plant pathogen population following contact with the composition.

In some embodiments, the efficacy of a composition on a plant pathogen may be measured by the percent inhibition of diameter growth (PIDG). In these embodiments, the PIDG after 7 days may be in the range of from 10% to 100%. The lower limit in some embodiments may be at least 10%, at least 14% or at least 31%. The upper limit in some embodiments may be 100%, no more than 84%, or no more than 72%. Any lower and upper limit may be combined without restriction. For example, the range may be between 10% and 72%, between 14% and 72%, between 31% and 84%, or between 31% and 100%.

As used herein, the term “plant pathogen” means fungi, oomycetes, and other similar organisms, particularly those fungi and oomycetes that affect commercially valuable crops. Such crops include, but are not limited to, banana, tobacco, avocado, palm (such as for palm oil), durian, pepper, cocoa, rubber, pumpkin, tomato, and strawberry. It is not the intention to limit the invention by the type of crop that the composition may be used on. Any crop that is infected with a plant pathogen, may be treated with compositions of the present invention. Preferred crops are discussed in further detail, below.

In some embodiments, the plant pathogen is an oomycete. In these embodiments, the oomycete belongs to the genus Phytophthora. In one embodiment, the oomycete is Phytophthora palmivora. In another embodiment, the oomycete is Phytophthora capsici. In yet another embodiment, the oomycete is Phytophthora cinnamomi. Phytophthora cinnamomi is a soil-borne water mould that produces an infection which causes a condition in plants called “root rot” or “dieback”. This pathogen is one of the world's most invasive species and is present in over 70 countries around the world.

In some embodiments, the plant pathogen is a fungus. In some embodiments, the fungus belongs to the genus Fusarium. Fusarium is a pathogen that causes very high economic loss in agricultural crops. An important example is Panama disease in bananas. In some embodiments, the fungus is Fusarium oxysporum. In one embodiment, the fungus is Fusarium oxysporum f. sp. Cubense (Foc).

In one embodiment, the benzalkonium compound has the following structure:

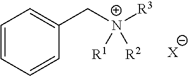

wherein R¹ and R² are, independently of each other, methyl or ethyl, R³ is alkyl, and X is a halide selected from the group consisting of fluoride, chloride, bromide and iodide. One advantage of this particular class of compound is that it is able to control populations of plant pathogens such as fungi and oomycetes, and when used at the appropriate concentration does not kill plants. In some embodiments, R¹ and R² are both methyl. In some embodiments, R¹ is methyl and R² is ethyl. In some embodiments, R¹ and R² are both ethyl. In one preferred embodiment, R¹ and R² are both methyl, R³ is alkyl, and X is chloride. In one embodiment, the benzalkonium compound is not identifiable as a penetration enhancer, or a surfactant, or a polymeric film-forming agent, in compositions of the present invention. In other words, in preferred embodiments, the benzalkonium compound is a separately-defined component.

As used herein, the term “alkyl” means a linear or branched alkyl chain of formula CₙH₂ₙ₊₁, where n indicates the number of carbon atoms in the alkyl chain. In some embodiments, R³ is linear or branched C₁-C₄₀ alkyl, such as linear or branched C₁-C₃₀ alkyl or linear or branched C₁-C₂₀ alkyl. In one preferred embodiment, R³ is linear or branched C₁₂-C₁₆ alkyl and X is chloride. The term “linear or branched” in the context of, for example, C₁₂-C₁₆ alkyl, means linear C₁₂-alkyl, linear C₁₄-alkyl, linear C₁₆-alkyl, branched C₁₂-alkyl, branched C₁₄-alkyl, branched C₁₆-alkyl, or any combination thereof. Benzalkonium compounds are typically solids, which are usually available as a solution, such as a 50% w/v solution in water or other solvent.

As used herein, the term “penetration enhancer” means a compound that facilitates penetration of the benzalkonium compound into the pathogen. Without wishing to be bound by theory, it is believed the penetration enhancer makes the plant pathogen more susceptible to the benzalkonium compound by aiding transport across pathogen cell walls. Penetration enhancers are typically multidentate structures that may be able to chelate to compounds such as the benzalkonium compound.

In one embodiment, the penetration enhancer is not identifiable as a benzalkonium compound, or a surfactant, or a polymeric film-forming agent. In other words, in preferred embodiments, the penetration enhancer is a separately-defined component. In some embodiments, the penetration enhancer is selected from the group consisting of ethylenediaminetetraacetic acid (EDTA), disodium EDTA, tetrasodium EDTA, and sodium calcium EDTA, or any combination thereof. In some embodiments, the penetration enhancer is a tripolyphosphate compound. In some embodiments, the tripolyphosphate compound is selected from the group consisting of lithium tripolyphosphate, sodium tripolyphosphate, and potassium tripolyphosphate, or any combination thereof. Tripolyphosphate compounds are inorganic compounds based on triphosphoric acid, and are distinct from phosphonate compounds such as methane diphosphonic acid (or salts thereof) which contain an organic component in their chemical structure. Tripolyphosphate compounds are used to advantage over phosphonate compounds. Phosphonate compounds have very different and inferior solubilising and penetrability as compared to tripolyphosphate compounds, with regard to aiding transport of compounds across pathogen cell walls. Tripolyphosphate compounds are particularly superior in this function in their interactions with cell walls specifically in fungi and oomycetes, even as compared with, for example, bacteria, The structures of triphosphoric acid and methane diphosphonic acid (medronic acid) are shown below:

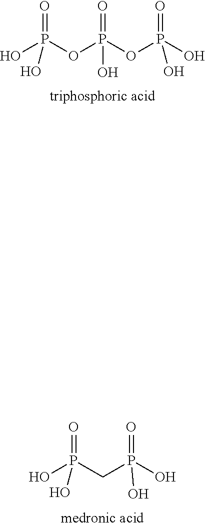 [SMILES: O=P(O)(O)OP(=O)(O)OP(=O)(O)O ; O=P(O)(O)CP(=O)(O)O]

The composition also contains a surfactant. As is well known in the art, a surfactant is able to reduce surface tension of water and assists, for example, dissolution of hydrophobic materials into aqueous solutions. The surfactant may be selected from the group consisting of cationic, anionic, amphoteric, or non-ionic surfactants. In one embodiment, the surfactant is not a benzalkonium compound, or a penetration enhancer, or a polymeric film-forming agent. In other words, in preferred embodiments, the surfactant is a separately-defined component. In some embodiments, the surfactant is a non-ionic surfactant. Non-ionic surfactants are surfactants that have a neutral charge in solution. Preferably the surfactant is low foaming, to assist with application of the composition to a plant. In some embodiments, the surfactant is not an anionic surfactant; or in other words, in some embodiments the surfactant is selected from the group consisting of a cationic surfactant, an amphoteric surfactant and a non-ionic surfactant. Anionic surfactants such as sodium lauryl sulfate and sodium laureth sulfate tend to form a foam upon mixing or agitation, which may be undesirable when preparing the composition for application to foliage, soil, or a crop of plants, such as by spraying. In preferred embodiments, the surfactant is a non-ionic surfactant.

A non-limiting example of a non-ionic surfactant is the class of compounds known as alcohol alkoxylate surfactants. A specific example of an alcohol alkoxylate surfactant is BL8 (trade name), which is described as a C9-11 alcohol alkoxylate. As this latter term suggests, this surfactant has a C9-C11 alkyl hydrophobic portion, and an alkoxylated (ethoxylated) hydrophilic portion that is capped by an alcohol group. The skilled person would understand that there are many variations possible within this class of surfactant, which is within the scope of the present invention. Another non-limiting example of a non-ionic surfactant is the class of compound known as alkylphenol alkoxylate surfactants. A specific example of an alkylphenol alkoxylate surfactant is Agral (trade name), which is described as a nonylphenol ethoxylate. As this latter term suggests, this surfactant has a nonylphenoxy hydrophobic portion, and an alkoxylated (ethoxylated) hydrophilic portion that is capped by an alcohol group. The Agral composition is prepared with 2-ethyl-1-hexanol as a co-solvent. The skilled person would understand that there are many variations possible within this class of surfactant, which is within the scope of the present invention. Another non-limiting example of a non-ionic surfactant is the class of compound known as polyether-modified siloxanes. A specific example of a polyether-modified siloxane is Hansa ADD 1055 (trade name), which is a mixture of alpha-methyl-omega-[3-[1,3,3,3-tetramethyl-1-[(trimethylsilyl)oxy]-1-disiloxanyl]propoxy]-poly(oxy-1,2-ethanediyl) and alpha-methyl-omega-(2-propen-1-yloxy)-poly(oxy-1,2-ethanediyl). The skilled person would understand that there are many variations possible within this class of surfactant, which is within the scope of the present invention.

In some embodiments, the surfactant is selected from the group consisting of an alcohol alkoxylate surfactant, an alkylphenol alkoxylate surfactant, and a polyether-modified siloxane surfactant, or any combination thereof. In some embodiments, the surfactant is a combination of an alcohol alkoxylate surfactant (such as BL8) and a polyether-modified siloxane surfactant (such as Hansa ADD 1055). In these embodiments, the volume ratio of alcohol alkoxylate surfactant to polyether-modified siloxane surfactant may be in the range of from 100:10 to 10:100. According to some embodiments, the alcohol alkoxylate surfactant is present in a greater amount than the polyether-modified siloxane surfactant, such as a volume ratio of 88:12, 80:20, 67:33, or 55:45. In some embodiments, the alcohol alkoxylate surfactant is present in a lesser amount than the polyether-modified siloxane surfactant, such as a volume ratio of 15:85, 20:80, 38:62, or 46:54. In one preferred embodiment, the volume ratio of alcohol alkoxylate surfactant to polyether-modified siloxane surfactant is about 66:34.

As used herein, the term “polymeric film-forming agent” means a polymeric compound that can form a film. In one embodiment, the polymeric film-forming agent is not a benzalkonium compound, or a penetration enhancer, or a surfactant. In other words, in preferred embodiments, the polymeric film-forming agent is a separately-defined component. The polymeric film-forming agent aids the other components in the composition to stick or persist on the surface of a plant or soil. Without wishing to be bound by theory, it is believed that the polymeric film-forming agent forms a film that binds to the components of the composition to the plant or soil, or maintains contact between the components and the plant or soil. It is also believed that the polymer has the ability to hold water or absorb water from the atmosphere. The polymeric film-forming agent, when present in the amounts recited herein, results in the formation of a tacky surface after evaporation of the solvent of the composition. The contact or adhesion may be via van der Waals forces, hydrogen bonds, electrostatic forces, covalent bonds, or any combination thereof. The polymeric film-forming agent allows the components to persist near the application site whilst resisting being washed away, such as by precipitation. The polymeric film-forming agent may be any polymeric compound that is able to hold onto the components as well as to a plant or soil substrate, is non-volatile, and preferably water-soluble. Cationic polymers are not considered to be suitable for application to higher plants, as there is evidence that growth is affected, as outlined by Kuboi et al. (Soil Science and Plant Nutrition 1984, 30, 311-320). Thus in some embodiments, the polymeric film-forming agent is not a cationic polymer. In some embodiments, the polymeric film-forming agent is a non-ionic polymer or an anionic polymer. In some embodiments, the polymeric film-forming agent is a non-ionic polymer. Classes of suitable polymeric film-forming agent include but are not limited to: polyacrylamides, cellulose derivatives, polyethylene glycols, and polysaccharides. Non-limiting examples of polyacrylamides that may be used as a polymeric film-forming agent include poly(acrylamide), poly(acrylic acid), poly(acrylate), poly(acrylamide-co-acrylic acid), and poly(acrylamide-co-acrylate), or any combination thereof. Suitable examples of these polymers may be found in the following patent applications, which are hereby incorporated herein by reference: WO 89/12450, WO 2013/149856 A1, WO 2016/162783 A1, and WO 2017/197066 A1. The preparation of such compounds has been reported, for example by Kalaleh et al. in “Preparation of poly(sodium acrylate-co-acrylamide) superabsorbent copolymer via alkaline hydrolysis of acrylamide using microwave irradiation” (arXiv:1502.03639), which is also incorporated herein by reference. These polymers are based on the monomers acrylamide, acrylic acid, and/or acrylic esters, and provide suitable adhesive properties to compositions for controlling plant pathogens. In one preferred embodiment, the polymeric film-forming agent is poly(acrylamide-co-acrylic acid), referred to herein as “acrylamide polymer”. Such agents are found to be particularly suited for the formation of a composition with the desired properties in the applications described herein.

Non-limiting examples of cellulose derivatives that may be used as a polymeric film-forming agent include carboxymethyl cellulose, methyl cellulose, ethyl methyl cellulose, hydroxyethyl cellulose, hydroxypropyl cellulose, hydroxypropyl methyl cellulose (HPMC), and hydroxyethyl methyl cellulose (HEMC). These polymers are cellulose-based polymers that differ in the functionalisation of the side chains. In one preferred embodiment, the polymeric film-forming agent is carboxymethyl cellulose.

Non-limiting examples of polyethylene glycols that may be used as a polymeric film-forming agent include PEG 6000 and PEG 8000. The polyethylene glycol in preferred embodiments may have a molecular weight of at least 3000, such as at least 3,500, at least 4,000 or at least 6,000. The upper limit on the molecular weight in some embodiments may be 10,000 or 8,000.

Non-limiting examples of polysaccharides that may be used as a polymeric film-forming agent include alginates, cellulose, pectin, cyclodextrin, dextran, starch, and chitosan.

The polymeric film-forming agent may be any combination of the above compounds.

In another aspect, the composition for controlling a plant pathogen comprises:
(a) a benzalkonium compound in an amount of from 10 wt % to 60 wt %;
(b) a penetration enhancer in an amount of from 1 wt % to 30 wt %;
(c) a surfactant in an amount of from 10 wt % to 70 wt %; and
(d) a polymeric film-forming agent in an amount of from 0 wt % to 2 wt %.

The amounts indicated for the composition exclude any solvent. Expressed another way, the solvent content is disregarded when assessing the relative amounts of components against the above percentage values. However, the composition is typically combined with a solvent prior to use.

In some embodiments, the amount of benzalkonium compound is present in an amount within the range of from 10 wt % to 60 wt %. The lower limit in the range, in some embodiments may be at least 10 wt %, at least 15 wt %, at least 20 wt %, or at least 38 wt %. The upper limit in the range may be no more than 60 wt %, no more than 50 wt %, no more than 45 wt %, or no more than 39 wt %. Any lower and upper limit may be combined without restriction. For example, the range may be between 10 wt % and 39 wt %, between 15 wt % and 45 wt %, between 20 wt % and 60 wt %, or between 38 wt % and 50 wt %. In some embodiments, the benzalkonium compound is benzalkonium chloride, which is present in an amount of about 39 wt %.

In some embodiments, the amount of penetration enhancer is present in an amount within the range of from 1 wt % to 30 wt %. Whilst it is considered that compositions may work without any penetration enhancer, it is considered that compositions containing some penetration enhancer show far greater efficacy than if none were present. The lower limit in the range, in some embodiments may be at least 1 wt %, at least 2 wt %, at least 5%, or at least 10 wt %. The upper limit in the range may be no more than 30 wt %, no more than 25 wt %, no more than 20 wt %, or no more than 11 wt %. Any lower and upper limit may be combined without restriction. For example, the range may be between 1 wt % and 11 wt %, between 2 wt % and 20 wt %, between 10 wt % and 30 wt %, or between 5 wt % and 25 wt %. In some embodiments, the penetration enhancer is sodium tripolyphosphate, which is present in an amount of about 11 wt %.

In some embodiments, the amount of surfactant is present in an amount within the range of from 10 wt % to 70 wt %. Whilst it is considered that compositions may work without any surfactant, it is considered that compositions containing some surfactant show far greater efficacy and/or spreadability, than if none were present. The lower limit in the range, in some embodiments may be at least 10 wt %, at least 20 wt %, at least 30 wt %, or at least 40 wt %. The upper limit in the range may be no more than 70 wt %, no more than 60 wt %, no more than 55 wt %, or no more than 50 wt %. Any lower and upper limit may be combined without restriction. For example, the range may be between 10 wt % and 55 wt %, between 20 wt % and 70 wt %, between 30 wt % and 60 wt %, or between 40 wt % and 50 wt %. In some embodiments, the surfactant is an alcohol alkoxylate surfactant, which is present in an amount of about 50 wt %. In some embodiments, the surfactant is a combination of an alcohol alkoxylate surfactant, which is present in an amount of about 33.5 wt %, and a polyether-modified siloxane, which is present in an amount of about 17 wt %. As such, the surfactants in this embodiment are present in an amount of about 51 wt %.

In some embodiments, the amount of polymeric film-forming agent is present in an amount within the range of from 0 wt % to 2 wt %. Compositions may control a plant pathogen, such as Fusarium or Phytophthora, without any polymeric film-forming agent. For example, when the composition is applied to directly to soil, it may be unnecessary to add the polymeric film-forming agent. In other embodiments, it is advantageous to add a polymeric film-forming agent, such as when the composition is applied to foliage of a plant, or to the fruit of a plant. In some embodiments, the lower limit in the range may be 0 wt %, at least 0.01 wt %, at least 0.02 wt %, or at least 0.05 wt %. The upper limit in the range may be no more than 2.00 wt %, no more than 1.50 wt %, no more than 1.00 wt %, or no more than 0.50 wt %. Any lower and upper limit may be combined without restriction. The polymeric film-forming agent may be absent. When present, the amount of polymeric film-forming agent may be present in the range between 0.01 wt % and 0.50 wt %, between 0.02 wt % and 1.00 wt %, between 0.05 wt % and 2.00 wt %, or between 0.02 wt % and 1.50 wt %. In some embodiments, the polymeric film-forming agent is poly(acrylamide-co-acrylic acid), which is present in an amount of about 0.09 wt %.

In some embodiments, the concentration (in ppm) of the composition in a state ready for application is calculated by reference to the total amount of component (a), the benzalkonium compound, where 1 mg/L is equivalent to 1 ppm.

The expression “whole-of-product concentration” may also be used to describe the concentration of a composition, where there is more than one component being stated. For example, the “whole-of-product concentration” (in ppm) for a composition with components X and Y is the combined mass of X and Y (in mg) per litre of solvent.

### Relative Amounts of Components (a) and (b)

In some embodiments, the concentration (in ppm) of the composition in a state ready for application is calculated by reference to the total amount of components (a) the benzalkonium compound and (b) the penetration enhancer. In this case, the concentration of the composition, expressed in ppm, is based on the combined mass of benzalkonium compound and penetration enhancer present (in mg) per litre of solvent. In these embodiments, the mass ratio of benzalkonium compound to penetration enhancer may be within the range of from 98:2 to 25:75. Without wishing to be bound by theory, it is thought that a specific ratio of benzalkonium compound to penetration enhancer may give rise to a synergistic effect. According to some embodiments, the benzalkonium compound is present in a greater amount than the penetration enhancer, such as a ratio of 92:8, 81:19, 75:25, or 67:33. In some embodiments, the benzalkonium compound is present in a lesser amount than the penetration enhancer, such as a ratio of 25:75, 31:69, 39:61, or 49:51. In some embodiments, the benzalkonium compound is benzalkonium chloride and the penetration enhancer is sodium tripolyphosphate. In such embodiments, the ratio of benzalkonium chloride to sodium tripolyphosphate is about 78:22.

### Relative Amounts of Components (a) and (c)

In some embodiments, the concentration (in ppm) of the composition in a state ready for application is calculated by reference to the total amount of components (a) the benzalkonium compound and (c) the surfactant. The surfactant may be a single surfactant or a combination of two or more surfactants. An advantage of having two different surfactants is that a better spectrum of properties such as spreadability, adherence, or efficacy may be obtained, compared to using just one or the other of the same surfactants. It may also be possible to reduce the total amount of surfactant added by use of a combination of surfactants. The concentration of the composition, expressed in ppm, is based on the combined mass of benzalkonium compound and surfactant(s) present (in mg) per litre of solvent. In these embodiments, the mass ratio of benzalkonium compound to surfactant(s) may be within the range of from 85:15 to 10:90. According to some embodiments, the benzalkonium compound is present in a greater amount than the surfactant(s), such as a ratio of 70:30, 67:33, 60:40, or 55:45. In some embodiments, the benzalkonium compound is present in a lesser amount than the surfactant(s), such as a ratio of 20:80, 25:75, 30:70, or 35:65. In some embodiments, the benzalkonium compound is benzalkonium chloride and the surfactant is an alcohol alkoxylate surfactant. In these embodiments, the ratio of benzalkonium chloride to alcohol alkoxylate surfactant is about 44:56. In some embodiments, the surfactant is a combination of an alcohol alkoxylate surfactant and a polyether-modified siloxane. In these embodiments, the ratio of benzalkonium chloride to surfactants is about 43:57.

### Relative Amounts of Components (a) and (d)

In some embodiments, the concentration (in ppm) of the composition in a state ready for application is calculated by reference to the total amount of components (a) the benzalkonium compound and (d) the polymeric film-forming agent. In this case, the concentration of the composition, expressed in ppm, is based on the combined mass of benzalkonium compound and polymeric film-forming agent present (in mg) per litre of solvent. In these embodiments, the mass ratio of benzalkonium compound to polymeric film-forming agent may be within the range of from 100:0 to 83:17. When the polymeric film-forming agent is present, the mass ratio of benzalkonium compound to polymeric film-forming agent may be, for example, within the range of between 100:0 to 90:10, 99.9:0.1 to 90:10, 99.9:0.1 to 95:5; 99.5:0.5 to 90:10; 98:2 to 95:5, or so forth. The amount may be about 99.9:0.1, 99.5:0.5, 98:2, 92:8, or 90:10. In some embodiments, the benzalkonium compound is benzalkonium chloride and the polymeric film-forming agent is poly(acrylamide-co-acrylic acid). The ratios above apply to such compositions. In one particular embodiment, the ratio of benzalkonium chloride to poly(acrylamide-co-acrylic acid) may be about 99.8:0.2.

Concentration for Compositions with Three Components

In some embodiments, the concentration (in ppm) of the composition in a state ready for application is calculated by reference to the total amount of components (a) benzalkonium compound, (b) penetration enhancer and (c) the surfactant(s). In this case, the concentration of the composition, expressed in ppm, is based on the combined mass of benzalkonium compound, penetration enhancer, and surfactant(s) present (in mg) per litre of solvent.

In some embodiments, the concentration (in ppm) of the composition in a state ready for application is calculated by reference to the total amount of components (a) benzalkonium compound, (b) penetration enhancer and (d) the polymeric film-forming agent. In this case, the concentration of the composition, expressed in ppm, is based on the combined mass of benzalkonium compound, penetration enhancer, and polymeric film-forming agent present (in mg) per litre of solvent.

In some embodiments, the concentration (in ppm) of the composition in a state ready for application is calculated by reference to the total amount of components (a) benzalkonium compound, (c) surfactant(s) and (d) polymeric film-forming agent. In this case, the concentration of the composition, expressed in ppm, is based on the combined mass of benzalkonium compound, surfactant(s), and polymeric film-forming agent present (in mg) per litre of solvent.

Concentration for Compositions with Four Components

In some embodiments, the concentration (in ppm) of the composition in a state ready for application is calculated by reference to the total amount of components (a) benzalkonium compound, (b) penetration enhancer, (c) surfactant(s), and (d) polymeric film-forming agent. In this case, the concentration of the composition, expressed in ppm, is based on the combined mass of benzalkonium compound, penetration enhancer, surfactant, and polymeric film-forming agent present (in mg) per litre of solvent.

Plant pathogens such as fungi and oomycetes, and their spores, often persist in soil for many years without the need for a plant host. Once a crop has been planted, the pathogen will then infect the roots, stem or crown of the plants. Thus, in another aspect, the present invention provides a use of a composition to control a plant pathogen in soil, comprising applying to the soil a composition comprising (a) a benzalkonium compound in an amount of from 10 wt % to 60 wt %, (b) a penetration enhancer in an amount of from 1 wt % to 30 wt %, (c) a surfactant in an amount of from 10 wt % to 70 wt %, and (d) a polymeric film-forming agent in an amount of from 0 wt % to 2 wt %. It has surprisingly been found that compositions of the present invention are able to control plant pathogen populations when applied at rates that are much lower than used previously for sterilising purposes. Furthermore, the inventors have shown for the first time that Phytophthora and Fusarium populations can be reduced or eliminated in a crop of plants, using compositions of the present invention. The composition may be applied to soil by any means to control the pathogen population in the soil, either before, during, or after a crop has been planted.

As used herein, the term “apply”, “applying” and similar terms means contacting a surface, such as a plant or soil, with a composition of the present invention. The composition may be applied to soil or seeds prior to planting, by spraying or watering onto soil, the trunk or foliage of established crops, by drenching of soil, by injection or implantation into the trunk of plants, by flooding of a field, or by aerial spraying. For the first time, the inventors have shown that the composition may be used to prevent infestation of a plant pathogen, such as Phytophthora or Fusarium, or to control or eliminate the plant pathogen, or to rehabilitate an area infested with the plant pathogen. The composition may be applied at a rate that is far lower than that used for sterilising equipment, which is typically used at a rate of about 100,000 ppm. At the low rates that the compositions of the present invention are used, it is surprising that the plant pathogen may be controlled to low levels without killing the affected plant or causing browning of leaves.

The plant pathogen may occur on the plant stem or trunk, leaves, or fruit, or any part of the plant that is above ground. Thus, in another aspect, the present invention provides a method of controlling a plant pathogen, comprising contacting the plant pathogen with an effective amount of a composition comprising (a) a benzalkonium compound in an amount of from 10 wt % to 60 wt %, (b) a penetration enhancer in an amount of from 1 wt % to 30 wt %, (c) a surfactant in an amount of from 10 wt % to 70 wt %, and (d) a polymeric film-forming agent in an amount of from 0 wt % to 2 wt %. The plant pathogen may also be found below ground, such as in the roots or in the soil.

In another aspect, the present invention provides a method of controlling a plant pathogen in a crop of plants, comprising applying to the crop a composition comprising (a) a benzalkonium compound in an amount of from 10 wt % to 60 wt %, (b) a penetration enhancer in an amount of from 1 wt % to 30 wt %, (c) a surfactant in an amount of from 10 wt % to 70 wt %, and (d) a polymeric film-forming agent in an amount of from 0 wt % to 2 wt %. A crop of plants means a field of plants or a plantation of plants. The method of applying the composition is not limited. For example, the composition may be applied to the crop by spraying, addition to a water supply, aerial application, or any other means.

In another aspect, the present invention provides a method of controlling a plant pathogen in soil, comprising applying to the soil a composition comprising (a) a benzalkonium compound in an amount of from 10 wt % to 60 wt %, (b) a penetration enhancer in an amount of from 1 wt % to 30 wt %, (c) a surfactant in an amount of from 10 wt % to 70 wt %, and (d) a polymeric film-forming agent in an amount of from 0 wt % to 2 wt %. In one embodiment, the soil is a field of soil. The field may have a crop planted in the field or the field may be bare. If the field is bare, the field may be treated with the composition to control the plant pathogen prior to planting. In these embodiments, the plant pathogen is an oomycete, a fungus, or a combination thereof. In one embodiment, the oomycete belongs to the genus Phytophthora. In another embodiment, the fungus belongs to the genus Fusarium.

### Method of Application

The composition of the present invention can be applied by any method known in the art. For example, the composition may be applied to the surface of a plant, beneath the surface of a plant, or into or onto the soil surrounding the plant. The pathogen being treated, cycle in the season, local geography and rainfall patterns, method of application, and equipment used, amongst other factors, will determine the concentration and application rate to be used. For example, treatment of Phytophthora will generally require a concentration of the composition of about one thirtieth to one third compared to that required to treat Fusarium. The invention is not limited by the method of application. In some embodiments, the composition may be applied to soil or seeds prior to planting, by spraying onto soil, the trunk or foliage of established crops, by drenching of soil, by injection or implantation into the trunk of plants, or by flooding of a field. The inventors have determined that application of the composition to an area infested with a plant pathogen can be made by any number of methods, as long as the composition contacts a plant, a fruit, or soil. Furthermore, it is surprising that a low amount of benzalkonium compound, applied to a plant, fruit or to soil, especially in a composition of the invention, is able to reduce or control the population of the plant pathogen. This is surprising, as many plant stems and fruit have a waxy coating that assists shedding of water, or any aqueous liquid, away from the plant and into the soil. Similarly, any water-based liquid applied to soil would be expected to drain away, along with any compounds dissolved in the water, and would therefore not be expected to treat a plant pathogen that may reside on the plant or in the soil such as in or around the roots of the plant. To the best of the inventors' knowledge, the control of a plant pathogen, such as Phytophthora or Fusarium, in a field or crop, has not been demonstrated with any composition comprising a benzalkonium compound.

### Concentration for Foliar Application for Treatment of Phytophthora

If the composition is applied to foliage for the treatment of Phytophthora, the concentration may be in the range of from 15 ppm to 750 ppm, based on the concentration of the benzalkonium compound. The lower limit in the range may be at least 15 ppm, or at least 20 ppm, at least 25 ppm, or at least 50 ppm, based on the concentration of the benzalkonium compound. The upper limit in the range may be no more than 750 ppm, no more than 500 ppm, no more than 200 ppm, or no more than 100 ppm. Any lower and upper limit may be combined without restriction. For example, the range may be between 15 ppm and 100 ppm, between 20 ppm and 200 ppm, between 25 ppm and 750 ppm, or between 50 ppm and 200 ppm, based on the concentration of the benzalkonium compound.

In some embodiments, the concentration of the composition is expressed as a “whole-of-product concentration”, wherein the term “whole-of-product” refers to a combination of the benzalkonium compound and the penetration enhancer. In this embodiment, if the composition is applied to foliage for the treatment of Phytophthora, the concentration of the composition may be in the range of from 15 ppm to 960 ppm. The lower limit in the range may be at least 15 ppm, at least 20 ppm, at least 50 ppm, or at least 100 ppm, based on the combined amounts of benzalkonium compound and penetration enhancer. The upper limit in the range may be no more than 960 ppm, no more than 500 ppm, no more than 300 ppm, or no more than 200 ppm, based on the combined amounts of benzalkonium compound and penetration enhancer. Any lower and upper limit may be combined without restriction. For example, the range may be between 15 ppm and 200 ppm, between 20 ppm and 300 ppm, between 50 ppm and 500 ppm, or between 100 ppm and 960 ppm, based on the combined amounts of benzalkonium compound and penetration enhancer.

In some embodiments, the concentration of the composition is expressed as a “whole-of-product concentration”, wherein the term “whole-of-product” refers to a combination of the benzalkonium compound and the surfactant(s). In this embodiment, if the composition is applied to foliage for the treatment of Phytophthora, the concentration of the composition may be in the range of from 30 ppm to 1720 ppm. The lower limit in the range may be at least 30 ppm, at least 50 ppm, at least 100 ppm, or at least 200 ppm, based on the combined amounts of benzalkonium compound and surfactant(s). The upper limit in the range may be no more than 1720 ppm, no more than 1000 ppm, no more than 500 ppm, or no more than 250 ppm, based on the combined amounts of benzalkonium compound and surfactant(s). Any lower and upper limit may be combined without restriction. For example, the range may be between 30 ppm and 250 ppm, between 50 ppm and 1000 ppm, between 100 ppm and 500 ppm, or between 200 ppm and 1720 ppm, based on the combined amounts of benzalkonium compound and surfactant(s).

In some embodiments, the concentration of the composition is expressed as a “whole-of-product concentration”, wherein the term “whole-of-product” refers to a combination of the benzalkonium compound and the polymeric film-forming agent. In this embodiment, if the composition is applied to foliage for the treatment of Phytophthora, the concentration of the composition may be in the range of from 15 ppm to 750 ppm. The lower limit in the range may be at least 15 ppm, at least 20 ppm, at least 25 ppm, or at least 50 ppm, based on the combined amounts of benzalkonium compound and polymeric film-forming agent. The upper limit in the range may be no more than 750 ppm, no more than 500 ppm, no more than 200 ppm, or no more than 100 ppm, based on the combined amounts of benzalkonium compound and polymeric film-forming agent. Any lower and upper limit may be combined without restriction. For example, the range may be between 15 ppm and 100 ppm, between 20 ppm and 200 ppm, between 25 ppm and 500 ppm, or between 50 ppm and 750 ppm, based on the combined amounts of benzalkonium compound and polymeric film-forming agent.

In some embodiments, the concentration of the composition is expressed as a “whole-of-product concentration”, wherein the term “whole-of-product” refers to a combination of the benzalkonium compound with the penetration enhancer, the surfactant(s), and the polymeric film-forming agent. In this embodiment, if the composition is applied to foliage for the treatment of Phytophthora, the concentration of the composition may be in the range of from 30 ppm to 1930 ppm. The lower limit in the range may be at least 30 ppm, at least 100 ppm, at least 200 ppm, or at least 300 ppm, based on the combined amounts of benzalkonium compound, penetration enhancer, surfactant(s), and polymeric film-forming agent. The upper limit in the range may be no more than 1930 ppm, no more than 1500 ppm, no more than 1000 ppm, or no more than 500 ppm, based on the combined amounts of benzalkonium compound, penetration enhancer, surfactant(s), and polymeric film-forming agent. Any lower and upper limit may be combined without restriction. For example, the range may be between 30 ppm and 500 ppm, between 100 ppm and 1000 ppm, between 200 ppm and 1500 ppm, or between 300 ppm and 1930 ppm, based on the combined amounts of benzalkonium compound, penetration enhancer, surfactant(s), and polymeric film-forming agent.

### Concentration for Soil Drenching for Treatment of Phytophthora

If the composition is applied to the soil, for example as a drench to the base of the plant, for the treatment of Phytophthora, the concentration may be in the range of from 30 ppm to 3500 ppm, based on the concentration of the benzalkonium compound. The lower limit in the range may be at least 30 ppm, at least 100 ppm, at least 200 ppm, or at least 500 ppm, based on the concentration of the benzalkonium compound. The upper limit in the range may be no more than 3500 ppm, no more than 2000 ppm, no more than 1500 ppm, or no more than 1000 ppm. Any lower and upper limit may be combined without restriction. For example, the range may be between 30 ppm and 1000 ppm, between 100 ppm and 3500 ppm, between 200 ppm and 2000 ppm, or between 500 ppm and 1500 ppm, based on the concentration of the benzalkonium compound.

In some embodiments, the concentration of the composition is expressed as a “whole-of-product concentration”, wherein the term “whole-of-product” refers to a combination of the benzalkonium compound and the penetration enhancer. In this embodiment, if the composition is applied to the soil for the treatment of Phytophthora, the concentration of the composition may be in the range of from 30 ppm to 4500 ppm. The lower limit in the range may be at least 30 ppm, at least 100 ppm, at least 500 ppm, or at least 1000 ppm, based on the combined amounts of benzalkonium compound and penetration enhancer. The upper limit in the range may be no more than 4500 ppm, no more than 3000 ppm, no more than 2000 ppm, or no more than 1500 ppm, based on the combined amounts of benzalkonium compound and penetration enhancer. Any lower and upper limit may be combined without restriction. For example, the range may be between 30 ppm and 1500 ppm, between 100 ppm and 2000 ppm, between 500 ppm and 3000 ppm, or between 1000 ppm and 4500 ppm, based on the combined amounts of benzalkonium compound and penetration enhancer.

In some embodiments, the concentration of the composition is expressed as a “whole-of-product concentration”, wherein the term “whole-of-product” refers to a combination of the benzalkonium compound and the surfactant(s). In this embodiment, if the composition is applied to soil for the treatment of Phytophthora, the concentration of the composition may be in the range of from 60 ppm to 8100 ppm. The lower limit in the range may be at least 60 ppm, at least 200 ppm, at least 500 ppm, or at least 1000 ppm, based on the amounts of benzalkonium compound and surfactant(s). The upper limit in the range may be no more than 8100 ppm, no more than 5000 ppm, no more than 3000 ppm, or no more than 2000 ppm, based on the combined amounts of benzalkonium compound and surfactant(s). Any lower and upper limit may be combined without restriction. For example, the range may be between 60 ppm and 2000 ppm, between 200 ppm and 3000 ppm, between 500 ppm and 5000 ppm, or between 1000 ppm and 8100 ppm, based on the combined amounts of benzalkonium compound and surfactant(s).

In some embodiments, the concentration of the composition is expressed as a “whole-of-product concentration”, wherein the term “whole-of-product” refers to a combination of the benzalkonium compound and the polymeric film-forming agent. In this embodiment, if the composition is applied to soil for the treatment of Phytophthora, the concentration of the composition may be in the range of from 30 ppm to 3500 ppm. The lower limit in the range may be at least 30 ppm, at least 100 ppm, at least 500 ppm, or at least 1000 ppm, based on the combined amounts of benzalkonium compound and polymeric film-forming agent. The upper limit in the range may be no more than 3500 ppm, no more than 2000 ppm, no more than 1500 ppm, or no more than 1200 ppm, based on the combined amounts of benzalkonium compound and polymeric film-forming agent. Any lower and upper limit may be combined without restriction. For example, the range may be between 30 ppm and 1200 ppm, between 100 ppm and 1500 ppm, between 500 ppm and 2000 ppm, or between 1000 ppm and 3500 ppm, based on the combined amounts of benzalkonium compound and polymeric film-forming agent.

In some embodiments, the concentration of the composition is expressed as a “whole-of-product concentration”, wherein the term “whole-of-product” refers to a combination of the benzalkonium compound with the penetration enhancer, the surfactant, and the polymeric film-forming agent. In this embodiment, if the composition is applied to soil for the treatment of Phytophthora, the concentration of the composition may be in the range of from 70 ppm to 9000 ppm. The lower limit in the range may be at least 70 ppm, at least 200 ppm, at least 500 ppm, or at least 1000 ppm, based on the combined amounts of benzalkonium compound, penetration enhancer, surfactant(s), and polymeric film-forming agent. The upper limit in the range may be no more than 9000 ppm, no more than 4000 ppm, no more than 2000 ppm, or no more than 1500 ppm, based on the combined amounts of benzalkonium compound, penetration enhancer, surfactant(s), and polymeric film-forming agent. Any lower and upper limit may be combined without restriction. For example, the range may be between 70 ppm and 1500 ppm, between 200 ppm and 2000 ppm, between 500 ppm and 4000 ppm, or between 1000 ppm and 9000 ppm, based on the combined amounts of benzalkonium compound, penetration enhancer, surfactant(s), and polymeric film-forming agent.

### Concentration for Foliar Application for Treatment of Fusarium

If the composition is applied to foliage for the treatment of Fusarium, the concentration may be in the range of from 200 ppm to 2000 ppm, based on the concentration of the benzalkonium compound. The lower limit in the range may be at least 200 ppm, at least 250 ppm, at least 300 ppm, or at least 350 ppm, based on the concentration of the benzalkonium compound. The upper limit in the range may be no more than 2000 ppm, no more than 800 ppm, no more than 500 ppm, or no more than 350 ppm. Any lower and upper limit may be combined without restriction. For example, the range may be between 200 ppm and 350 ppm, between 250 ppm and 500 ppm, between 300 ppm and 800 ppm, or between 350 ppm and 2000 ppm, based on the concentration of the benzalkonium compound.

In some embodiments, the concentration of the composition is expressed as a “whole-of-product concentration”, wherein the term “whole-of-product” refers to a combination of the benzalkonium compound and the penetration enhancer. In this embodiment, if the composition is applied to foliage for the treatment of Fusarium, the concentration of the composition may be in the range of from 250 ppm to 2600 ppm. The lower limit in the range may be at least 250 ppm, at least 300 ppm, at least 350 ppm, or at least 400 ppm, based on the combined amounts of benzalkonium compound and penetration enhancer. The upper limit in the range may be no more than 2600 ppm, no more than 1500 ppm, no more than 800 ppm, or no more than 400 ppm, based on the combined amounts of benzalkonium compound and penetration enhancer. Any lower and upper limit may be combined without restriction. For example, the range may be between 250 ppm and 400 ppm, between 300 ppm and 800 ppm, between 350 ppm and 1500 ppm, or between 400 ppm and 2600 ppm, based on the combined amounts of benzalkonium compound and penetration enhancer.

In some embodiments, the concentration of the composition is expressed as a “whole-of-product concentration”, wherein the term “whole-of-product” refers to a combination of the benzalkonium compound and the surfactant(s). In this embodiment, if the composition is applied to foliage for the treatment of Fusarium, the concentration of the composition may be in the range of from 450 ppm to 4600 ppm. The lower limit in the range may be at least 450 ppm, at least 500 ppm, at least 550 ppm, or at least 600 ppm, based on the combined amounts of benzalkonium compound and surfactant(s). The upper limit in the range may be no more than 4600 ppm, no more than 2000 ppm, no more than 1000 ppm, or no more than 600 ppm, based on the combined amounts of benzalkonium compound and surfactant(s). Any lower and upper limit may be combined without restriction. For example, the range may be between 450 ppm and 600 ppm, between 500 ppm and 1000 ppm, between 550 ppm and 2000 ppm, or between 600 ppm and 4600 ppm, based on the combined amounts of benzalkonium compound and surfactant(s).

In some embodiments, the concentration of the composition is expressed as a “whole-of-product concentration”, wherein the term “whole-of-product” refers to a combination of the benzalkonium compound and the polymeric film-forming agent. In this embodiment, if the composition is applied to foliage for the treatment of Fusarium, the concentration of the composition may be in the range of from 200 ppm to 2000 ppm. The lower limit in the range may be at least 200 ppm, at least 250 ppm, at least 300 ppm, or at least 350 ppm, based on the combined amounts of benzalkonium compound and polymeric film-forming agent. The upper limit in the range may be no more than 2000 ppm, no more than 1000 ppm, no more than 500 ppm, or no more than 350 ppm, based on the combined amounts of benzalkonium compound and polymeric film-forming agent. Any lower and upper limit may be combined without restriction. For example, the range may be between 200 ppm and 350 ppm, between 250 ppm and 500 ppm, between 300 ppm and 1000 ppm, or between 350 ppm and 2000 ppm, based on the combined amounts of benzalkonium compound and polymeric film-forming agent.

In some embodiments, the concentration of the composition is expressed as a “whole-of-product concentration”, wherein the term “whole-of-product” refers to a combination of the benzalkonium compound with the penetration enhancer, the surfactant, and the polymeric film-forming agent. In this embodiment, if the composition is applied to foliage for the treatment of Fusarium, the concentration of the composition may be in the range of from 500 ppm to 5200 ppm. The lower limit in the range may be at least 500 ppm, at least 600 ppm, at least 700 ppm, or at least 800 ppm, based on the combined amounts of benzalkonium compound, penetration enhancer, surfactant(s), and polymeric film-forming agent. The upper limit in the range may be no more than 5200 ppm, no more than 3000 ppm, no more than 1500 ppm, or no more than 800 ppm, based on the combined amounts of benzalkonium compound, penetration enhancer, surfactant(s), and polymeric film-forming agent. Any lower and upper limit may be combined without restriction. For example, the range may be between 500 ppm and 800 ppm, between 600 ppm and 1500 ppm, between 700 ppm and 3000 ppm, or between 800 ppm and 5200 ppm, based on the combined amounts of benzalkonium compound, penetration enhancer, surfactant(s), and polymeric film-forming agent.

### Concentration for Soil Drenching for Treatment of Fusarium

If the composition is applied to the soil, for example as a drench to the base of the plant, for the treatment of Fusarium, the concentration of the composition may be in the range of from 500 ppm to 10000 ppm, based on the concentration of the benzalkonium compound. The lower limit in the range may be at least 500 ppm, at least 600 ppm, at least 800 ppm, or at least 1200 ppm, based on the concentration of the benzalkonium compound. The upper limit in the range may be no more than 10,000 ppm, no more than 5000 ppm, no more than 2000 ppm, or no more than 1200 ppm. Any lower and upper limit may be combined without restriction. For example, the range may be between 500 ppm and 1200 ppm, between 600 ppm and 2000 ppm, between 800 ppm and 5000 ppm, or between 1200 ppm and 10000 ppm, based on the concentration of the benzalkonium compound.

In some embodiments, the concentration of the composition is expressed as a “whole-of-product concentration”, wherein the term “whole-of-product” refers to a combination of the benzalkonium compound and the penetration enhancer. In this embodiment, if the composition is applied to the soil for the treatment of Fusarium, the concentration of the composition may be in the range of from 630 ppm to 13000 ppm. The lower limit in the range may be at least 630 ppm, at least 700 ppm, at least 1000 ppm, or at least 1500 ppm, based on the combined amounts of benzalkonium compound and penetration enhancer. The upper limit in the range may be no more than 13,000 ppm, no more than 6000 ppm, no more than 3000 ppm, or no more than 1,500 ppm, based on the combined amounts of benzalkonium compound and penetration enhancer. Any lower and upper limit may be combined without restriction. For example, the range may be between 630 ppm and 1500 ppm, between 700 ppm and 3000 ppm, between 1000 ppm and 6000 ppm, or between 1500 ppm and 13000 ppm, based on the combined amounts of benzalkonium compound and penetration enhancer.

In some embodiments, the concentration of the composition is expressed as a “whole-of-product concentration”, wherein the term “whole-of-product” refers to a combination of the benzalkonium compound and the surfactant(s). In this embodiment, if the composition is applied to soil for the treatment of Fusarium, the concentration of the composition may be in the range of from 1140 ppm to 23000 ppm. The lower limit in the range may be at least 1140 ppm, at least 1200 ppm, at least 2000, or at least 3000 ppm, based on the combined amounts of benzalkonium compound and surfactant(s). The upper limit in the range may be no more than 23,000 ppm, no more than 12,000 ppm, no more than 6,000 ppm, or no more than 3,000 ppm, based on the combined amounts of benzalkonium compound and surfactant(s). Any lower and upper limit may be combined without restriction. For example, the range may be between 1140 ppm and 3000 ppm, between 1200 ppm and 6000 ppm, between 2000 ppm and 12000 ppm, or between 3000 ppm and 23000 ppm, based on the combined amounts of benzalkonium compound and surfactant(s).

In some embodiments, the concentration of the composition is expressed as a “whole-of-product concentration”, wherein the term “whole-of-product” refers to a combination of the benzalkonium compound and the polymeric film-forming agent. In this embodiment, if the composition is applied to soil for the treatment of Fusarium, the concentration of the composition may be in the range of from 500 ppm to 10000 ppm. The lower limit in the range may be at least 500 ppm, at least 600 ppm, at least 700 ppm, or at least 800 ppm, based on the combined amounts of benzalkonium compound and polymeric film-forming agent. The upper limit in the range may be no more than 10,000 ppm, no more than 4000 ppm, no more than 1500 ppm, or no more than 800 ppm, based on the combined amounts of benzalkonium compound and polymeric film-forming agent. Any lower and upper limit may be combined without restriction. For example, the range may be between 500 ppm and 800 ppm, between 600 ppm and 1500 ppm, between 700 ppm and 4000 ppm, or between 800 ppm and 10000 ppm, based on the combined amounts of benzalkonium compound and polymeric film-forming agent.

In some embodiments, the concentration of the composition is expressed as a “whole-of-product concentration”, wherein the “whole-of-product” refers to a combination of the benzalkonium compound with the penetration enhancer, the surfactant, and the polymeric film-forming agent. In this embodiment, if the composition is applied to soil for the treatment of Fusarium, the concentration of the composition may be in the range of from 1280 ppm to 26000 ppm. The lower limit in the range may be at least 1280 ppm, at least 1500 ppm, at least 2000 ppm, or at least 2500 ppm, based on the combined amounts of benzalkonium compound, penetration enhancer, surfactant(s), and polymeric film-forming agent. The upper limit in the range may be no more than 26,000 ppm, no more than 12,000 ppm, no more than 5,000 ppm, or no more than 2,500 ppm, based on the combined amounts of benzalkonium compound, penetration enhancer, surfactant(s), and polymeric film-forming agent. Any lower and upper limit may be combined without restriction. For example, the range may be between 1280 ppm and 2500 ppm, between 1500 ppm and 5000 ppm, between 2000 ppm and 12000 ppm, or between 2500 ppm and 26000 ppm, based on the combined amounts of benzalkonium compound, penetration enhancer, surfactant(s), and polymeric film-forming agent.

The skilled person would be able to calculate the corresponding “whole-of-product concentration”, based on the amounts of each component in a composition and whether the concentration is based on a combination of 2, 3, or 4 components.

### Application Rate

Taking into account the above composition concentrations, the amount of composition applied per 100 linear metres can readily be calculated by the skilled person. The term “per 100 linear metres” refers to application of a composition using a spraying device that may be driven along a line in an orchard or field of crop plants. The amount of composition applied per 100 linear metres will depend on a number of factors, such as foliar application versus application directed to the soil, type of pathogen being treated, maturity of plants, plant size (height, width, density of leaves), row spacing, distance between trees within each row, equipment used (type of spray nozzle used, such as wide angle or narrow angle nozzles, droplet size, pressure of delivery), season, and type of crop, amongst other factors. The composition may be applied at a rate of 5 to 50 L/100 linear metres, preferably 20 to 25 L/100 linear metres. The following application rates are based on applying 5 to 50 L of composition per 100 linear metres.

### Application Rate for Foliar Application for Treatment of Phytophthora

For foliar application for the treatment of Phytophthora, the composition may be applied at a rate of from 0.075 g to 37.5 g/100 linear metres, based on the amount of benzalkonium compound delivered per 100 linear metres. The lower limit in the range may be at least 0.075 g/100 linear metres, at least 0.15 g/100 linear metres, at least 0.50 g/100 linear metres, or at least 2.00 g/100 linear metres, based on the amount of benzalkonium compound delivered per 100 linear metres. The upper limit in the range may be no more than 37.5 g/100 linear metres, no more than 20.0 g/100 linear metres, no more than 10.0 g/100 linear metres, or no more than 3.00 g/100 linear metres, based on the amount of benzalkonium compound delivered per 100 linear metres. Any lower and upper limit may be combined without restriction. For example, the range may be between 0.075 g to 3.00 g/100 linear metres, between 0.15 g to 10.0 g/100 linear metres, between 0.50 g to 20.0 g/100 linear metres, or between 2.00 g to 37.5 g/100 linear metres, based on the amount of benzalkonium compound delivered per 100 linear metres.

### Application Rate for Soil Drenching for Treatment of Phytophthora

For application to soil for the treatment of Phytophthora, the composition may be applied at a rate of from 0.15 g to 175 g/100 linear metres, based on the amount of benzalkonium compound delivered per 100 linear metres. The lower limit in the range may be at least 0.15 g/100 linear metres, at least 1.00 g/100 linear metres, at least 2.00 g/100 linear metres, or at least 5.00 g/100 linear metres, based on the amount of benzalkonium compound delivered per 100 linear metres. The upper limit in the range may no more than 175 g/100 linear metres, no more than 80.0 g/100 linear metres, no more than 25.0 g/100 linear metres, or no more than 10.0 g/100 linear metres, based on the amount of benzalkonium compound delivered per 100 linear metres. Any lower and upper limit may be combined without restriction. For example, the range may be between 0.15 g to 10.0 g/100 linear metres, between 1.00 g to 25.0 g/100 linear metres, between 2.00 g to 80.0 g/100 linear metres, or between 5.00 g to 175 g/100 linear metres, based on the amount of benzalkonium compound delivered per 100 linear metres.

### Application Rate for Foliar Application for Treatment of Fusarium

For foliar application for the treatment of Fusarium, the composition may be applied at a rate of from 1.0 g to 100 g/100 linear metres, based on the amount of benzalkonium compound delivered per 100 linear metres. The lower limit in the range may be at least 1.00 g/100 linear metres, at least 2.00 g/100 linear metres, at least 5.00 g/100 linear metres, or at least 10.0 g/100 linear metres, based on the amount of benzalkonium compound delivered per 100 linear metres. The upper limit in the range may be no more than 100 g/100 linear metres, no more than 50.0 g/100 linear metres, no more than 20.0 g/100 linear metres, or no more than 12.0 g/100 linear metres, based on the amount of benzalkonium compound delivered per 100 linear metres. Any lower and upper limit may be combined without restriction. For example, the range may be between 1.00 g to 12.0 g/100 linear metres, between 2.00 g to 20.00 g/100 linear metres, between 5.00 g to 50.0 g/100 linear metres, or between 10.0 g to 100 g/100 linear metres, based on the amount of benzalkonium compound delivered per 100 linear metres.

### Application Rate for Soil Drenching for Treatment of Fusarium

For application to soil for the treatment of Fusarium, the composition may be applied at a rate of from 2.50 g to 500 g/100 linear metres, based on the amount of benzalkonium compound delivered per 100 linear metres. The lower limit in the range may be at least 2.50 g/100 linear metres, at least 5.00 g/100 linear metres, at least 10.0 g/100 linear metres, or at least 15.0 g/100 linear metres, based on the amount of benzalkonium compound delivered per 100 linear metres. The upper limit in the range may be no more than 500 g/100 linear metres, no more than 200 g/100 linear metres, no more than 100 g/100 linear metres, or no more than 20.0 g/100 linear metres, based on the amount of benzalkonium compound delivered per 100 linear metres. Any lower and upper limit may be combined without restriction. For example, the range may be between 2.50 g to 20.0 g/100 linear metres, between 5.00 g to 100 g/100 linear metres, between 10.0 g to 200 g/100 linear metres, or between 15.0 g to 500 g/100 linear metres, based on the amount of benzalkonium compound delivered per 100 linear metres.

The skilled person would be able to calculate the corresponding “whole-of-product” application rates, based on the amounts of each component in a composition and whether the concentration is based on a combination of 2, 3, or 4 components.

### Crops

The crop that may be treated with the composition of the present invention is not limited. For example, the crop may be selected from the group consisting of banana, tobacco, avocado, palm (for palm oil), durian, pepper, cocoa, rubber, pumpkin, tomato, and strawberry.

### Spreadability

Compositions of the present invention that contain a polymeric film-forming agent, display favourable spreadability and adherence to surfaces, compared to compositions that do not contain the polymeric film-forming agent. Spreadability may be assessed by comparison of droplet area on a surface, or contact angle of a droplet, for a composition with and without the polymeric film-forming agent. A greater droplet area indicates a greater spread, which is a desirable feature in an agricultural composition. A smaller contact angle is also an indicator of a greater spread. Adherence to a surface may be assessed by placing a droplet of the composition on the surface, and measuring the angle required to tilt the surface in order to move the droplet in a downwards direction. An angle that is greater than the control composition (with no polymeric film-forming agent) is a stickier, more adhesive composition, which is a desirable feature of the present compositions.

In some embodiments, for a composition with a concentration of BAC of 500 ppm and a concentration of polymeric film-forming agent of 0.2 mL/L, the increase in spreadability on glass, as measured by an increase in droplet area compared to a control solution which does not contain any polymeric film-forming agent, is between 30% to 80%. The lower limit in the range may be at least 30%, at least 35%, at least 40%, or at least 45%. The upper limit in the range may be no more than 80%, no more than 70%, no more than 60%, or no more than 50%. Any lower and upper limit may be combined without restriction. For example, the range may be between 30% to 50%, between 35% to 60%, between 40% to 70%, or between 45% to 80%. In a preferred embodiment, wherein the polymeric film-forming agent is an acrylamide polymer, the increase in spreadability compared to control is about 55%.

In other embodiments, for a composition with a concentration of BAC of 1000 ppm and a concentration of polymeric film-forming agent of 0.2 mL/L, the increase in spreadability on glass, as measured by an increase in droplet area compared to a control solution which does not contain any polymeric film-forming agent is between 65% to 105%. The lower limit in the range may be at least 65%, at least 70%, at least 75%, or at least 80%. The upper limit in the range may be no more than 100%, no more than 95%, no more than 90%, or no more than 85%. Any lower and upper limit may be combined without restriction. For example, the range may be between 65% to 85%, between 70% to 90%, between 75% to 95%, or between 80% to 105%. In a preferred embodiment, wherein the polymeric film-forming agent is an acrylamide polymer, the increase in spreadability compared to control is about 84%.

In some embodiments, for a composition with a concentration of BAC of 500 ppm (or 1000 ppm), and a concentration of acrylamide polymer of 0.2 mL/L, the contact angle on glass is between 5° and 25°. The lower limit in the range may be at least 5°, at least 6°, at least 7°, or at least 8°. The upper limit in the range may be no more than 25°, no more than 20°, no more than 15°, or no more than 10°. Any lower and upper limit may be combined without restriction. For example, the range may be between 5° and 10°, between 6° and 15°, between 7° and 20°, or between 8° and 25°. In some preferred embodiments, wherein the concentration of acrylamide polymer is 0.2 mL/L, the contact angle on glass is about 120.

In other embodiments, for a composition with a concentration of BAC of 2000 ppm and a concentration of polymeric film-forming agent of 0.2 mL/L, the increase in spreadability on glass, as measured by an increase in droplet area compared to a control solution which does not contain any polymeric film-forming agent is between 5% to 30%. The lower limit in the range may be at least 5%, at least 8%, at least 12%, or at least 15%. The upper limit in the range may be no more than 30%, no more than 25%, no more than 20%, or no more than 15%. Any lower and upper limit may be combined without restriction. For example, the range may be between 5% to 15%, between 8% to 20%, between 12% to 25%, or between 15% to 30%. In a preferred embodiment, wherein the polymeric film-forming agent is an acrylamide polymer, the increase in spreadability compared to control is about 18%.

In other embodiments, for a composition with a concentration of BAC of 2000 ppm and a concentration of polymeric film-forming agent of 0.2 mL/L, the increase in tilt angle required to move a droplet in a downward direction, on a glass surface, compared to a control solution which does not contain any polymeric film-forming agent is between 2% to 20%. The lower limit in the range may be at least 2%, at least 5%, at least 8%, or at least 10%. The upper limit in the range may be no more than 120%, no more than 18%, no more than 15%, or no more than 12%. Any lower and upper limit may be combined without restriction. For example, the range may be between 2% to 12%, between 5% to 15%, between 8% to 18%, or between 10% to 20%. In a preferred embodiment, wherein the polymeric film-forming agent is an acrylamide polymer, the increase in spreadability compared to control is about 10%.

### EXAMPLES

The present invention will now be more fully described by reference to the following non-limiting Examples.

### Example 1—Composition 1

### Materials

The benzalkonium compound used was benzalkonium chloride (CAS No. 8001-54-5, referred to herein as ‘BAC’), available as a 50% w/v solution in water. The penetration enhancer used was sodium tripolyphosphate (CAS No. 7758-29-4, referred to herein as “STPP”), Na₅P₃O₁₀, also known as sodium triphosphate.

One surfactant used was BL8 (CAS No. 102782-43-4), a non-ionic C9-11 alcohol alkoxylate surfactant also known as polyoxyalkylene glycol fatty alcohol ether, with an approximate molecular weight of 640. The density of this surfactant is approximately 0.970 g/mL. Another surfactant used was Hansa ADD 1055, which may be classified as a non-ionic surfactant. Hansa ADD 1055 is a mixture of polyethylene glycol mono(3-(tetramethyl-1-(trimethylsiloxy)-disiloxanyl)propyl)ether (CAS No. 27306-78-1; 70-90% w/w) and alpha-methyl-omega-(2-propen-1-yloxy)-poly(oxy-1,2-ethanediyl) (CAS No. 27252-80-8; 20-30% w/w). The density of this surfactant is approximately 0.990 g/mL. Another surfactant used was Agral, which may be classified as a non-ionic surfactant, and is a mixture of nonyl phenol ethylene oxide condensate (CAS No. 9016-45-9; 63% w/v) and 2-ethyl-1-hexanol (CAS No. 104-76-7; 10-30% w/v), with the mass balance being made with other unspecified non-hazardous ingredients. The specific gravity for this surfactant is listed as 0.99 g/cm³.

The polymeric film-forming agent used was a copolymer of 2-propenamide and 2-propenoic acid sodium salt, referred to herein as poly(acrylamide-co-acrylic acid) or simply as “acrylamide polymer”. The density of the polymer is approximately 1.074 g/mL.

Initial work was based on a solution comprising the following components, with the balance made up to 1 L with water:

TABLE 1
Composition for treatment of fungal pathogens.

| | | Concentration |
|---|---|---|
| Component | Amount used | (g/L) |

| | | | |
|---|---|---|---|
| BAC (50% w/v in water) | 180 | mL | 90 |
| STPP | 25 | g | 25 |
| BL8 | 120 | mL | 116.4 |
| Acrylamide polymer | 0.2 | mL | 0.2148 |

### Example 2—Composition 2

An alternative formulation was prepared using the same components as above, with the further addition of the surfactant Hansa ADD 1055, as described above. The components used in this alternative formulation were as follows, with the balance made up to 1 L with water:

TABLE 2
Alternative composition for treatment of fungal pathogens.

| | | Concentration |
|---|---|---|
| Component | Amount used | (g/L) |

| | | | |
|---|---|---|---|
| BAC (50% w/v in water) | 180 | mL | 90 |
| STPP | 25 | g | 25 |
| BL8 | 80 | mL | 77.6 |
| Hansa ADD 1055 | 40 | mL | 39.6 |
| Acrylamide polymer | 0.2 | mL | 0.2148 |

### Example 3—In Vitro Testing Against Phytophthora palmivora

In vitro tests were performed against Phytophthora palmivora, the pathogen responsible for pod rot of cocoa, stem canker of durian and rubber, and foot rot of pepper, using a poison agar method as discussed below.

A stock solution was prepared with (a) BAC (50% w/v in water, 180 mL), (b) STPP (25 g), and (c) BL8 (120 mL), with enough water to provide a total volume of 1 L.

Corn meal agar (CMA, 17 g) medium (Oxoid™, Thermo Scientific) was added to distilled or deionized water (1 L) in accordance with the manufacturer's instruction before autoclaving at 121° C. for 20 minutes and cooling to 50-55° C. in a water bath. To the resulting mixture was added the stock solution described above, in accordance with the amounts in Table 3, or sterile distilled water (control sample). Five replications for each treatment were prepared, and the experiment was carried out using a completely randomized design (CRD).

TABLE 3
Poison agar compositions prepared for Phytophthora testing.

| Volume | Volume | | Whole-of- | Whole-of-product |
|---|---|---|---|---|
| of | of | | product | concentration for |
| stock | CMA | | concentration | BAC + STPP + |
| solution | media | Concentration | for BAC + | BL8 + polymer |
| (mL) | (mL) | of BAC (ppm) | STPP (ppm) | (ppm) |
| 150.00 | 850.00 | 13500 | 17250 | 34742 |
| 125.00 | 875.00 | 11250 | 14375 | 28952 |
| 100.00 | 900.00 | 9000 | 11500 | 23161 |
| 75.00 | 925.00 | 6750 | 8625 | 17371 |
| 50.00 | 950.00 | 4500 | 5750 | 11581 |
| 20.00 | 980.00 | 1800 | 2300 | 4632 |
| 10.00 | 990.00 | 900 | 1150 | 2316 |
| 5.00 | 995.00 | 450 | 575 | 1158 |
| 4.00 | 996.00 | 360 | 460 | 926 |
| 3.00 | 997.00 | 270 | 345 | 695 |
| 2.00 | 998.00 | 180 | 230 | 463 |
| 1.00 | 999.00 | 90.0 | 115 | 232 |
| 0.80 | 999.20 | 72.0 | 92.0 | 185 |
| 0.60 | 999.40 | 54.0 | 69.0 | 139 |
| 0.40 | 999.60 | 36.0 | 46.0 | 92.6 |
| 0.20 | 999.80 | 18.0 | 23.0 | 46.3 |
| 0.10 | 999.90 | 9.00 | 11.5 | 23.2 |
| 0.05 | 999.95 | 4.50 | 5.75 | 11.6 |
| 0.01 | 999.99 | 0.90 | 1.15 | 2.32 |

Mycelial growth in each treatment was recorded within seven days after incubation at room temperature with natural dark/light cycle in reference to the growth of the control. Percent inhibition of diameter growth (% PIDG) was calculated as follows:

$$Percent inhibition ( \% ) = [ ( dc - dt ) / dc ] \times 100$$

where: dc=average diameter of fungal colony in the control plate, and
   dt=average diameter of fungal colony in the treatment plate.

Analyses of statistical data were carried out using the standard analysis of variance (ANOVA) procedure using SAS software (version 9.2).

First round: 6 target concentrations were prepared and screened: 13500 ppm, 11250 ppm, 9000 ppm, 6750 ppm, 4500 ppm, 1800 ppm, 900 ppm and 450 ppm (concentrations of BAC, as shown in Table 3). All resulted in 100% inhibition of the growth of P. palmivora.

Second round: 6 target concentrations were prepared and screened: 450 ppm, 360 ppm, 270 ppm, 180 ppm, 90 ppm and 0 ppm (concentrations are for BAC, as shown in Table 3). All compositions containing BAC resulted in 100% inhibition of the growth of P. palmivora.

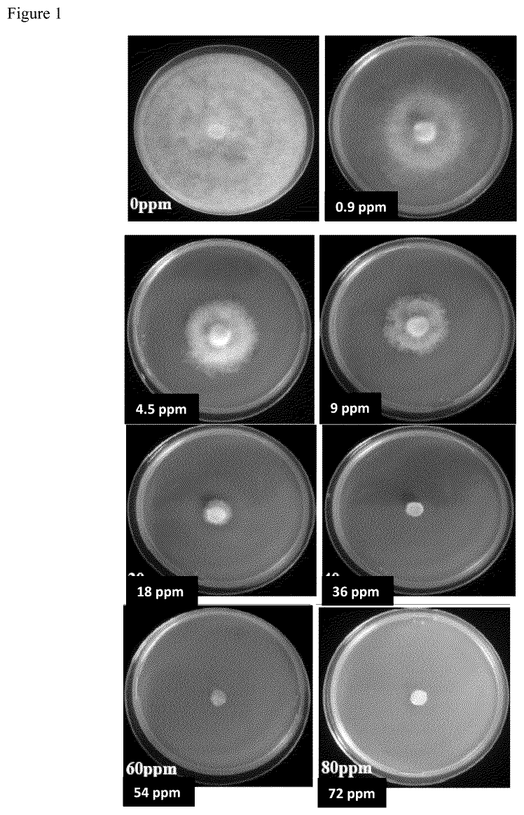

Third round: 8 target concentrations were prepared and screened: 72 ppm, 54 ppm, 36 ppm, 18 ppm, 9 ppm, 4.5 ppm, 0.9 ppm and 0 ppm (concentrations are for BAC, as shown in Table 3). Results are shown in FIG. 1. Average data for all replicates is summarised below in Table 4:

TABLE 4
Mycelial growth of P. palmivora at various concentrations
of composition at 5 and 7 days after incubation.

| | Growth | | Growth | |
|---|---|---|---|---|
| Concentration | after 5 d | PIDG | after 7 d | PIDG |
| of BAC (ppm) | (mm) | after 5 d | (mm) | after 7 d |
| 0.9 | 19.64 | 15.92 | 17.25 | 26.79 |
| 4.5 | 13.24 | 43.32 | 10.91 | 53.70 |
| 9 | 11.88 | 49.14 | 9.28 | 60.60 |
| 18 | 4.84 | 79.28 | 4.91 | 79.15 |
| 36 | 0 | 100 | 0 | 100 |
| 54 | 0 | 100 | 0 | 100 |
| 72 | 0 | 100 | 0 | 100 |

From the above data, an effective concentration for controlling an oomycete such as Phytophthora is from 15-750 ppm of BAC.

### Example 4—In Vitro Testing Against Fusarium oxysporum f. Sp. Cubense TR4

In vitro tests were performed against Fusarium oxysporum f. sp. cubense TR4 (FocTR4), the fungal pathogen responsible for Panama wilt of banana, using a poison agar method as discussed below.

Potato dextrose agar (PDA, 39 g) medium (Difco™) was added to distilled or deionized water (1 L) in accordance with the manufacturer's instruction before autoclaving at 121° C. for 20 minutes and cooling to 50-55° C. in a water bath. To the resulting mixture was added the stock solution of Example 3, in accordance with the amounts in Table 5, or sterile distilled water (control sample). Five replications for each treatment were prepared, and the experiment was carried out using a completely randomized design (CRD).

Mycelial growth in each treatment was recorded within seven days after incubation at room temperature with natural dark/light cycle in reference to the growth of the control. Percent inhibition of diameter growth (% PIDG) was calculated as described above. Analyses of statistical data were carried out using the standard analysis of variance (ANOVA) procedure using SAS software (version 9.2).

TABLE 5
Poison agar compositions prepared for Fusarium testing.

| Volume | Volume | | Whole-of- | Whole-of-product |
|---|---|---|---|---|
| of | of | | product | concentration for |
| stock | PDA | | concentration | BAC + STPP + |
| solution | media | Concentration | for BAC + | BL8 + polymer |
| (mL) | (mL) | of BAC (ppm) | STPP (ppm) | (ppm) |
| 150.00 | 850.00 | 13500 | 17250 | 34742 |
| 125.00 | 875.00 | 11250 | 14375 | 28952 |
| 100.00 | 900.00 | 9000 | 11500 | 23161 |
| 75.00 | 925.00 | 6750 | 8625 | 17371 |
| 50.00 | 950.00 | 4500 | 5750 | 11581 |
| 5.00 | 995.00 | 450 | 575 | 1158 |
| 4.00 | 996.00 | 360 | 460 | 926 |
| 3.00 | 997.00 | 270 | 345 | 695 |
| 2.00 | 998.00 | 180 | 230 | 463 |
| 1.00 | 999.00 | 90.0 | 115 | 232 |

First round: 6 target concentrations were prepared and screened: 13500 ppm, 11250 ppm, 9000 ppm, 6750 ppm, 4500 ppm and 0 ppm (concentration of BAC, as shown in Table 5). All compositions containing BAC resulted in 100% inhibition of the growth of FocTR4.

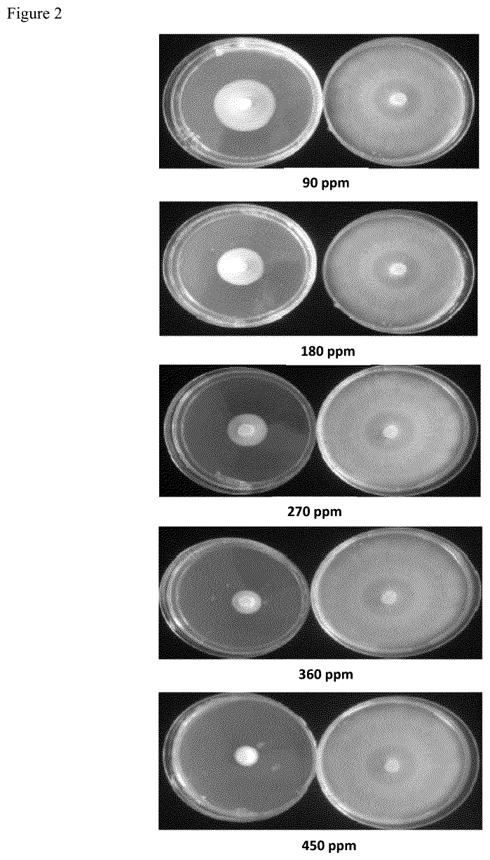

Second round: 6 target concentrations were prepared and screened: 450 ppm, 360 ppm, 270 ppm, 180 ppm, 90 ppm and 0 ppm (concentration of BAC, as shown in Table 5). Results are shown in FIG. 2. Average data for all replicates is summarised below in Table 6.

TABLE 6
Mycelial growth of FocTR4 at various concentrations
of composition at 7 days after incubation.

| | Growth | |
|---|---|---|
| Concentration | after 7 d | PIDG |
| of BAC (ppm) | (mm) | after 7 d |
| 0 | 23.57 | 0.00 |
| 90 | 9.29 | 60.59 |
| 180 | 7.00 | 70.30 |
| 270 | 5.86 | 75.14 |
| 360 | 4.43 | 81.20 |
| 450 | 3.00 | 87.27 |

From the above data, an effective concentration for controlling a fungus such as Fusarium is from 500-2000 ppm of BAC.

### Example 5—In Vivo Testing Against Phytophthora palmivora Using Cocoa Pods

The efficacy of a fungicidal composition of the present invention was tested against P. palmivora. Healthy, green cocoa pods were picked, prior to artificial inoculation with Phytophthora isolate M5. One highly virulent P. palmivora isolate (MI 5 from Sabah) with 5 replicates (pods) were used as the control.

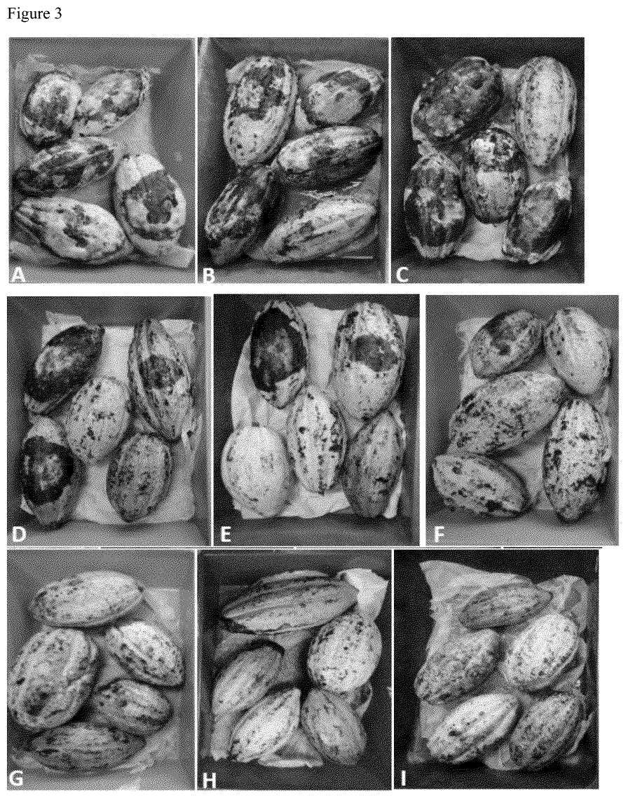

Each pod was washed carefully three times with sterile distilled water, the surface was disinfected for 2 minutes in 75% ethanol, and pods were air-dried at room temperature (25±2° C.). Different concentrations of the composition of the present invention (0-540 ppm) were prepared as for Examples 3 and 4, using the composition described in Example 1 which contained a polymeric film-forming agent, and spread on the pod surface to cover the whole pod. Cocoa pods with sterile distilled water were included as a negative control. After spreading, the pre-treated pods were inoculated with a 12 mm plug of 5-day old culture of P. palmivora grown on CMA plates by placing over the intact skin at the centre of each cocoa pod (see FIGS. 3A-I). The resulting pods were kept in moist plastic trays, covered with black polythene sheets to maintain moisture level, and incubated at 25±2° C. in the dark for seven days.

As can be seen from FIG. 3, the fungicidal composition of the present invention showed suppression against P. palmivora using the direct contact method described above. The data is summarised below:

TABLE 7
Mycelial growth of P. palmivora on cocoa pods at various concentrations
of fungicidal composition at 7 days after incubation.

| | Growth | |
|---|---|---|
| Concentration | after 7 d | PIDG |
| (ppm) | (mm) | after 7 d |
| 0 | 117.2 | 0.00 |
| 18 | 80.2 | 31.57 |
| 36 | 71.6 | 38.91 |
| 54 | 44.0 | 62.46 |
| 72 | 19.2 | 83.62 |
| 90 | 0.0 | 100 |
| 180 | 0.0 | 100 |
| 360 | 0.0 | 100 |
| 540 | 0.0 | 100 |

From the above data, an effective concentration for controlling an oomycete such as P. palmivora when applied to the fruit is between 15-750 ppm of BAC.

### Example 6—In Vivo Testing Against Phytophthora palmivora Using Durian Fruit

Healthy durian fruits were harvested carefully from a durian plantation, for artificial inoculation with Phytophthora isolate DB4. Untreated durian fruits with five replicates were used as the control. Fungicidal compositions were prepared, as for Example 5, then applied to the fruit surface. Durian fruits with sterile distilled water were included as a negative control. The pre-treated fruits were inoculated with a 12 mm plug of a 5-day old culture of P. palmivora grown on CMA plates by placing over the intact skin at the centre of each fruit. The resulting durian fruits were kept in moist plastic trays, covered with black polythene sheets to maintain moisture level, and incubated at 25±2° C. in the dark for seven days. Measurement of lesions were made at seven days after inoculation.

The fungicidal composition of the present invention showed suppression against P. palmivora using the direct contact method described above. The data is summarised below:

TABLE 8
Mycelial growth of P. palmivora on durian
fruits at various concentrations of fungicidal
composition at 7 days after incubation.

| | Growth | |
|---|---|---|
| Concentration | after 7 d | PIDG |
| (ppm) | (mm) | after 7 d |
| 0 | 90.8 | 0.00 |
| 18 | 90.2 | 0.66 |
| 36 | 78.0 | 14.10 |
| 54 | 56.8 | 37.44 |
| 72 | 25.6 | 71.81 |
| 90 | 2.4 | 97.36 |
| 180 | 0.0 | 100 |
| 360 | 0.0 | 100 |
| 540 | 0.0 | 100 |

From the above data, an effective concentration for controlling an oomycete such as P. palmivora when applied to the fruit is between 15-750 ppm of BAC.

### Example 7—Experiment to Assess the Spreadability of Test Compositions

When applying a liquid composition to a plant surface it is desirable that the composition has good spreadability, to maximise the surface area that can be covered when the composition is applied. Insufficient spread leads to “spotting” on the leaves. The spreadability due to the polymeric film-forming agent was tested using with two compositions, one at a low concentration (500 ppm) and one at a high (1000 ppm) concentration of BAC to gauge the effect at different concentrations, as discussed below.

### Compositions

A concentrated stock solution was prepared with BAC (50% w/v, 180 mL), STPP (25 g), BL8 (80 mL), and enough water to take the final volume to 1 L. The concentration of this stock solution was 90,000 ppm (based on the concentration of BAC). The stock solution was diluted with deionized water to prepare control solutions of 500 ppm and 1000 ppm concentration (concentration of BAC), which did not contain any polymeric film-forming agent. Test solutions containing acrylamide polymer (0.2 mL/L) as the polymeric film-forming agent were also prepared from the stock solution, with concentrations of BAC of 500 ppm (Test solution 1) and 1000 ppm (Test solution 2).

### Method 1—Droplet Area

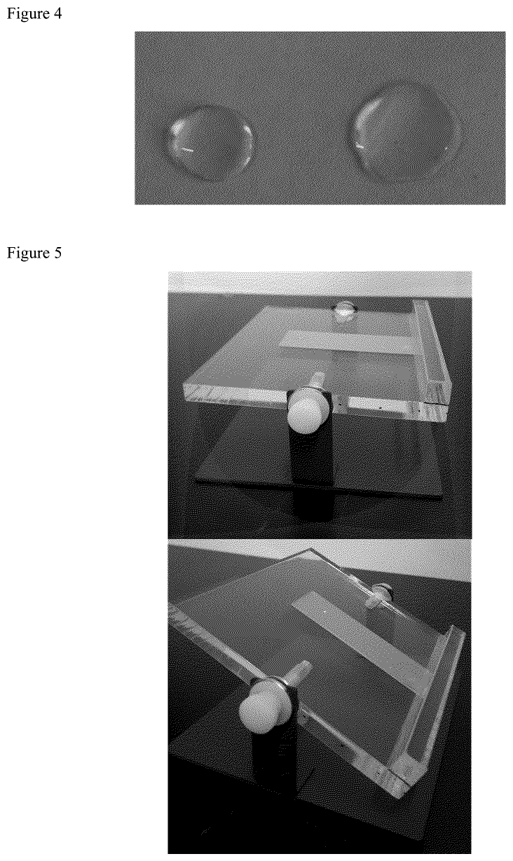

Droplet area was assessed with the test solutions containing the acrylamide polymer, compared to the relevant control solution (with no acrylamide polymer). A 40 μL droplet was applied to a glass microscope slide (FIG. 4a). After a period of 5 minutes, the droplet was photographed and the area of each droplet was quantified using Digimizer Image Analysis software. This process was repeated on a glass slide coated with camauba wax (FIG. 4b). Fifteen replicates were assessed at each concentration. The larger the area, the greater the spreadability of the composition.

Droplet areas were calculated and are presented as a percentage increase or decrease compared to the relevant control solution. To identify statistical differences between each test solution, the data was analysed by one-way ANOVA. Where significant differences were identified, pairwise comparison were made by Tukey's Honestly Significant Difference (HSD). All data was analysed using IBM SPSS Statistics for Windows (2020), Version 22.0. Armonk, NY: IBM Corp.

### Results

The test solutions containing acrylamide polymer at 500 ppm and 1000 ppm showed an increase in spreadability on glass, compared to the relevant control solutions. The increase in spreadability due to the acrylamide polymer was between 55-84% (Table 9).

TABLE 9
Increase in droplet area on a glass surface, compared to control.

| | Increase in area |
|---|---|
| Composition | (%) |
| Test solution 1 (500 ppm of | 55.13 (24.17) |
| BAC) | |
| Test solution 2 (1000 ppm pf | 84.08 (20.38) |
| BAC) | |

Mean values are presented (n = 15) and values in brackets represent ± standard deviation.

### Method 2—Contact Angle

Contact angle of a 5 μL droplet was measured according to the method of Huang et al. (Journal of Open Source Software 2021, 6, 2604), on glass microscope slides. The contact angle was measured on five droplets of each solution, with the measurement of each droplet repeated three times. The lower the contact angle, the greater the spread of the droplet.

To identify statistical differences between each test solution, the data was analysed by one-way ANOVA. Where significant differences were identified, pairwise comparison were made by Tukey's Honestly Significant Difference (HSD). All data was analysed using IBM SPSS Statistics for Windows (2020), Version 22.0. Armonk, NY: IBM Corp.

### Results

The contact angle results for each test solution correlated well with the droplet area results. On the glass surface at both 500 and 1000 ppm, addition of the acrylamide polymer significantly decreased the contact angle compared to the control solution alone. At 500 ppm, the control solution had a contact angle of approximately 27.70, whilst the solution containing acrylamide polymer had a greatly decreased contact angle of about 12.0°, indicating increased spreadability (Table 10). Similar results were obtained at 1000 ppm. The results are summarized below:

TABLE 10
Contact angle of the test solutions.

| | Contact angle |
|---|---|
| Composition | on glass (°) |
| Control 1 (500 ppm of BAC) | 27.71 (7.55)^{A} |
| Test solution 1 (500 ppm of BAC) | 12.02 (4.93)^{B} |
| Control 2 (1000 ppm of BAC) | 26.36 (3.60)^{A} |
| Test solution 2 (1000 ppm of BAC) | 12.13 (3.08)^{B} |

Mean values are presented (n = 5) and the values in brackets represent ± standard deviation. Within each surface type and concentration, mean values with the same letter are not statistically different as assessed by Tukey's HSD.

### Example 8—Experiment to Assess the Spreadability of Test Compositions

The above experiments in relation to droplet area were repeated with a composition (Test solution 3) comprising acrylamide polymer (0.2 mL/L) at a concentration of 2000 ppm (based on concentration of BAC). The composition was prepared as for Example 7. The experiments were conducted on glass slides, as discussed in Example 7.

The adherence of a droplet of a composition was also assessed by measurement of the angle required to move a droplet in a downward direction. A glass microscope slide was placed onto a tilt-capable platform and a 40 μL droplet of the test solution was pipetted 1 cm from the top edge (FIG. 5). The droplet was allowed to stabilise for 1 min. After this time, the platform was tilted by 2 mm every 5 sec until the droplet began to move down the slide. The tilt angle of the platform was then measured. This was repeated five times for the test solution.

Tilt angle was calculated and are presented as a percentage increase or decrease compared to the control solution. To identify statistical differences between each test solution, the data was analysed by one-way ANOVA. Where significant differences were identified, pairwise comparison were made by Tukey's Honestly Significant Difference (HSD). All data was analysed using IBM SPSS Statistics for Windows (2020), Version 22.0. Armonk, NY: IBM Corp.

### Results

TABLE 11
Droplet area and tilt angle required for droplet
to move along a glass surface, expressed as a percentage
increase compared to the control solution.

| | Increase in | Increase in |
|---|---|---|
| Composition | area (%)^{A} | tilt angle (%)^{B} |
| Test solution 3 (2000 ppm of BAC) | 18.40 (18.16) | 9.65 (7.19) |

^{A}Mean values with n = 15; brackets represent ± standard deviation.
^{B}Mean values with n = 5; brackets represent ± standard deviation.

### Example 9—Experiment to Assess the Spreadability of Test Compositions

The spreadability of a composition comprising a polymeric film-forming agent, on a range of different surfaces, was assessed in accordance to the protocols in Example 7.

### Compositions

A composition comprising BAC and acrylamide polymer, in accordance with Example 2, was prepared for testing. The solution was agitated on a platform mixer for 10 min at 120 rpm and prepared fresh before use.

### Surfaces

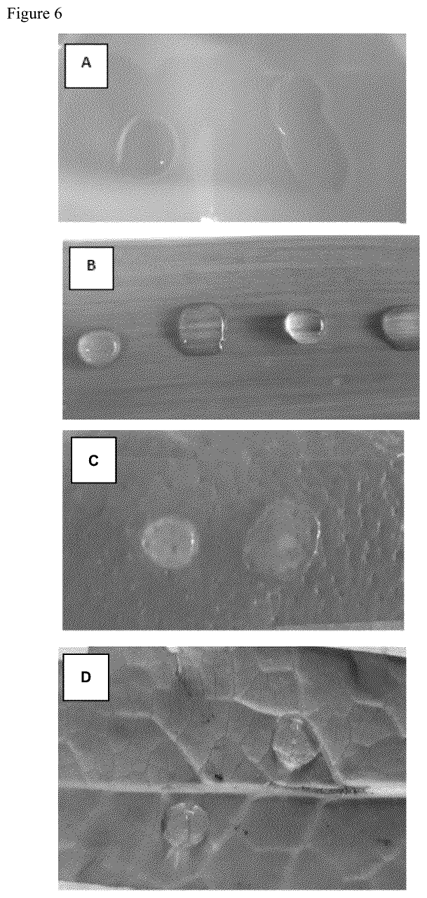

Droplet spreading was conducted on glass, leek, orange peel, and the underside of leaf tissue of Hypochaeris radicata, also known as cat's ear weed. The preparation of each surface is shown in Table 12. Surface textures are depicted in FIG. 6.

TABLE 12
Preparation and features of surfaces.

| Surface | Description | Surface preparation |
|---|---|---|
| Glass | Smooth, no | Inspected for scratches and |
| | imperfections | imperfections. Cleaned with |
| | | ethanol and dried with |
| | | lint-free tissue |
| Leek (dark green | Waxy, ridged | Sectioned to ensure a |
| section) | | flat surface |
| Orange peel | Dimpled | and taped down to prevent |
| Hypochaeris radicata | Underside of the | spreading bias. The |
| (cat's ear weed) | leaf is highly | surface was wiped with |
| | textured with | lint-free tissue to |
| | veins | remove any debris. |

### Method

Ten droplets of the solution to be tested were placed alongside a respective droplet of the control solution (deionized water) for comparison. The volume of each droplet was 70 μL and was dispensed with a micropipette to ensure consistency of volume. The maximum spread of each droplet was achieved after 5 minutes. Thereafter, a photo was taken of each pair of droplets. The outer edge of each droplet was demarcated manually and image processing software (JImage) used to calculate the area of each droplet. All droplets increased in size, compared to the control solution. The percentage increase in droplet size compared to the control solution was then calculated.

### Results

On all surfaces tested, the acrylamide polymer solution increased droplet spread when compared with deionized water (Table 13).

TABLE 13
Change in droplet area, expressed as a percentage
increase compared to the control solution.

| Surface | Test solution |
|---|---|
| Glass | 105.83 |
| | (56.99) |
| Leek | 126.14 |
| | (33.57) |
| Orange peel | 112.00 |
| | (32.90) |
| Hypochaeris radicata | 112.42 |
| (cat's ear) | (44.44) |

Mean values are presented (n = 10) and values in brackets represent ± standard deviation.

### Example 10—In Vivo Testing Against Fusarium oxysporum f. Sp. Cubense TR4 Using Banana Plants

The efficacy of a fungicidal composition of the present invention was tested against Fusarium oxysporum f. sp. cubense TR4 (FocTR4), the fungal pathogen responsible for Panama wilt of banana, for use as a preventative.

Banana seedlings (cv. Berangan, 2-month-old) were obtained from Malaysian Agricultural Research and Development Institute (MARDI). Soil was prepared in polybags and sterilized using a large capacity autoclave at the Institute of Plantation Sciences (IKP). Seedlings were allowed to acclimatize in a greenhouse for approximately two months, reaching a height of about 50 cm, before being inoculated with FocTR4. Plants were watered with a dripping system, and fertilized with NPK.

The seedlings were used in a randomized complete block design (RCBD) with seven treatments: healthy control, disease control, four concentrations (100 ppm, 300 ppm, 500 ppm and 700 ppm), and a commercial fungicide. For the four concentrations tested, compositions were either a test solution as described in Example 2, or a polymer control (as described in Example 1 with acrylamide polymer omitted). The concentrations used were based on the “whole-of-product”, as described above. The commercial fungicide was Nativo® (containing tebuconazole 50% w/w and trifloxystrobin 25% w/w) which was used at 1 g/L as per manufacturer instructions.

Four replications were used for each treatment, with four plants per replicate. 500 mL of each solution was added to each polybag at 1 and 3 days before inoculation. Seedlings were then inoculated with 10 mL of a spore suspension, injected 5 cm above the rhizomes with a hypodermic syringe. Seedlings were assessed after inoculation to measure disease incidence (DI) and disease severity (DSI). DI was measured by recording the number of plants in any one group that showed signs of infection. DSI was measured by estimating the proportion of plant surface area was infected. Statistical analysis was conducted using SAS® software and comparison of means using least significant difference (LSD) at 5% probability level. Average data for all replicates is summarised below in Table 14:

TABLE 14
Mean percentage of Fusarium wilt disease incidence and severity observed on banana
plants using polymer control versus test solution as a preventative treatment.

| | | | | Disease Incidence | | Disease Severity | |
|---|---|---|---|---|---|---|---|
| | | | | (DI, %) | | (DSI, %) | |
| | Conc 1 | Conc 2 | Conc 3 | Polymer | Test | Polymer | Test |
| Solution | (ppm) | (ppm) | (ppm) | control | solution | control | solution |
| Healthy | 0 | 0 | 0 | 0.00 | 0.00 | 0.00 | 0.00 |
| control | | | | | | | |
| Disease | 0 | 0 | 0 | 100.00 | 100.00 | 100.00 | 100.00 |
| Control | | | | | | | |
| A | 100 | 39 | 49 | 100.00 | 100.00 | 80.00 | 73.75 |
| B | 300 | 116 | 148 | 100.00 | 100.00 | 62.50 | 45.00 |
| C | 500 | 194 | 247 | 75.00 | 75.00 | 37.50 | 28.75 |
| D | 700 | 271 | 346 | 75.00 | 68.75 | 40.00 | 22.50 |
| Fungicide | 750 | — | — | 100.00 | 100.00 | 93.75 | 91.25 |

Conc 1 = whole-of-product concentration for BAC + STPP + surfactants + polymer (ppm).
Conc 2 = Concentration of BAC (ppm).
Conc 3 = whole-of-product concentration for BAC + STPP (ppm).

From the above data, an effective concentration for controlling a fungus such as Fusarium, when applied to the soil, is from 500-2000 ppm of BAC.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-29. (canceled)

30. A composition for controlling a plant pathogen, wherein the composition comprises:
(a) a benzalkonium compound;
(b) a penetration enhancer which is a tripolyphosphate compound;
(c) a surfactant; and
(d) a polymeric film-forming agent,
wherein the surfactant is selected from the group consisting of a cationic surfactant, an amphoteric surfactant and a non-ionic surfactant.

31. The composition according to claim 30, wherein the composition comprises each of (a) to (d) as a separate component.

32. The composition according to claim 30, wherein the benzalkonium compound has the following structure: 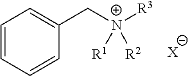
wherein R¹ and R² are, independently of each other, methyl or ethyl;
R³ is alkyl; and
X is a halide.

33. The composition according to claim 32, wherein R³ is linear or branched C₁₂-C₁₆ alkyl, and/or wherein X is chloride.

34. The composition according to claim 30, wherein the benzalkonium compound is present in an amount of from 10 wt % to 60 wt %, preferably from 20 wt % to 45 wt %, based on the total mass of components (a), (b), (c) and (d).

35. The composition according to claim 30, wherein the tripolyphosphate compound is selected from the group consisting of lithium tripolyphosphate, sodium tripolyphosphate, and potassium tripolyphosphate, or any combination thereof, preferably wherein the tripolyphosphate compound is sodium tripolyphosphate.

36. The composition according to claim 30, wherein the tripolyphosphate compound is present in an amount of from 1 wt % to 30 wt %, preferably from 5 wt % to 20 wt %, based on the total mass of components (a), (b), (c) and (d).

37. The composition according to claim 30, wherein the surfactant is a non-ionic surfactant, preferably wherein the non-ionic surfactant is selected from the group consisting of an alcohol alkoxylate surfactant, an alkylphenol alkoxylate surfactant, and a polyether-modified siloxane surfactant, or any combination thereof.

38. The composition according to claim 30, wherein the surfactant is present in an amount of from 10 wt % to 70 wt %, preferably from 30 wt % to 60 wt %, based on the total mass of components (a), (b), (c) and (d).

39. The composition according to claim 30, wherein the polymeric film-forming agent is selected from the group consisting of poly(acrylamide), poly(acrylic acid), poly(acrylate), poly(acrylamide-co-acrylic acid), and poly(acrylamide-co-acrylate).

40. The composition according to claim 30, wherein the polymeric film-forming agent is present in an amount of from 0.01 wt % to 2 wt %, preferably from 0.05 wt % to 0.5 wt %, based on the total mass of components (a), (b), (c) and (d).

41. A method of controlling a plant pathogen, comprising contacting the plant pathogen, applying to a crop of plants containing the plant pathogen, or applying to soil containing the plant pathogen, with an effective amount of a composition comprising (a) a benzalkonium compound, (b) a penetration enhancer which is a tripolyphosphate compound, (c) a surfactant, and (d) a polymeric film-forming agent, wherein the surfactant is selected from the group consisting of a cationic surfactant, an amphoteric surfactant and a non-ionic surfactant.

42. The method according to claim 41, wherein the plant pathogen is a fungus, oomycete, or combination thereof.

43. The method according to claim 42, wherein the oomycete belongs to the genus Phytophthora.

44. The method according to claim 42, wherein the fungus belongs to the genus Fusarium.

45. The method according to claim 43, wherein the composition is applied to foliage of a plant at a concentration of from 15 ppm to 750 ppm, based on the concentration of the benzalkonium compound, or wherein the composition is applied to soil at a concentration of from 30 ppm to 3500 ppm, based on the concentration of the benzalkonium compound.

46. The method according to claim 44, wherein the composition is applied to foliage of a plant at a concentration of from 200 ppm to 2000 ppm, based on the concentration of the benzalkonium compound, or wherein the composition is applied to soil at a concentration of from 500 ppm to 10000 ppm, based on the concentration of the benzalkonium compound.

47. A method of controlling Phytophthora and/or Fusarium, comprising contacting the plant pathogen, applying to a crop of plants containing the plant pathogen, or applying to soil containing the plant pathogen, with an effective amount of a composition comprising (a) a benzalkonium compound, (b) a penetration enhancer which is a tripolyphosphate compound, and (c) a surfactant, wherein the surfactant is selected from the group consisting of a cationic surfactant, an amphoteric surfactant and a non-ionic surfactant.
